(19) United States
(12) Patent Application Publication
(10) Pub. No.: US 2021/0268646 A1
(43) Pub. Date: Sep. 2, 2021

(54) ROBOT, METHOD FOR CONTROLLING ROBOT, AND COMPUTER PROGRAM

(71) Applicant: SONY CORPORATION, TOKYO (JP)

(72) Inventors: KAZUHITO WAKANA, TOKYO (JP); KIYOKAZU MIYAZAWA, TOKYO (JP); KAZUO HONGO, TOKYO (JP); TETSUYA NARITA, TOKYO (JP)

(21) Appl. No.: 17/250,420

(22) PCT Filed: Apr. 25, 2019
(86) PCT No.: PCT/JP2019/017821

§ 371 Date: Jan. 19, 2021

(30) Foreign Application Priority Data
Jul. 30, 2018 (JP) 2018-142829

(51) Int. Cl. B25J 9/16; B25J 9/00; B25J 15/04; B25J 15/08; B25J 19/02

(52) U.S. Cl. CPC B25J 9/163; B25J 9/0009; B25J 19/023; B25J 15/08; B25J 15/0441

(57) ABSTRACT

A robot includes a replacement determination unit (73) determining timing to replace a cover attachable to and detachable from part of a surface of a robot main member in accordance with a determination standard corresponding to usage of the robot, and a cover replacement unit (77, 78) controlling processing of replacing the cover with the robot main member on the basis of a result of the determination.

### FIELD

The present disclosure relates to a robot, a method for controlling a robot, and a computer program.

### BACKGROUND

A technique of holding an object in a state in which a protective cover is attached to a robot hand is known. This technique suppresses adhesion of foreign substances adhering to the surface of the object to the robot hand.

### CITATION LIST

### Patent Literature

Patent Literature 1: Japanese Patent Application Laid-open No. 2002-127066

Patent Literature 2: Japanese Patent Application Laid-open No. 2017-113836

### SUMMARY

### Technical Problem

However, the conventional art described above has the problem that the user operating the robot is required to judge the period of replacement of the protective cover.

For this reason, the present disclosure proposes a robot, a method for controlling a robot, and a computer program enabling autonomous determination of presence/absence of replacement of the cover attached to the robot.

### Solution to Problem

According to the present disclosure, a robot is provided that includes: a replacement determination unit determining timing to replace a cover attachable to and detachable from part of a surface of a robot main member in accordance with a determination standard corresponding to usage of the robot; and a cover replacement unit controlling processing of replacing the cover with the robot main member on the basis of a result of the determination.

### Advantageous Effects of Invention

The present disclosure enables autonomous determination of presence/absence of replacement of the cover attached to the robot. The effects described herein are not necessarily limited, but may be any of the effects described in the present disclosure.

### BRIEF DESCRIPTION OF DRAWINGS

FIG. 1 is a perspective view illustrating an example of appearance of a robot according to a first embodiment of the present disclosure.

FIG. 2 is a perspective view illustrating an example of appearance of a hand of the robot.

FIG. 3 is a cross-sectional view schematically illustrating an example of the hand.

FIG. 4 is a perspective view illustrating an example of a structure of a protective cover attached to the robot according to the first embodiment of the present disclosure.

FIG. 5 is a perspective view illustrating an example of the structure of the protective cover attached to the robot according to the first embodiment of the present disclosure, as viewed from a bottom side.

FIG. 6 is a cross-sectional view schematically illustrating an example of the protective cover.

FIG. 7 is a diagram illustrating appearance of the hand to which the protective cover is attached.

FIG. 8 is a perspective view illustrating an example of a cover replacement device.

FIG. 9 is a cross-sectional view schematically illustrating an example of the cover replacement device.

FIG. 10 is a block diagram illustrating an example of a functional configuration of a control device of the robot according to the first embodiment of the present disclosure.

FIG. 11 is a diagram illustrating an example of replacement determination conditions according to the first embodiment.

FIG. 12 is a diagram illustrating an example of cover usage information.

FIG. 13 is a flowchart illustrating an example of a processing procedure of attaching and detaching the protective cover according to the first embodiment of the present disclosure.

FIG. 14 is a diagram schematically illustrating an example of a state of checking an attachment state of the protective cover in the robot.

FIG. 15 is a flowchart illustrating an example of a procedure of protective cover attachment processing according to the first embodiment.

FIG. 16 is a perspective view schematically illustrating a state in which the robot approaches the protective cover of the cover replacement device.

FIG. 17 is a diagram schematically illustrating a state in which the hand of the robot is attached to the protective cover of the cover replacement device.

FIG. 18A is a cross-sectional view schematically illustrating a state of attachment of the protective cover (No. 1).

FIG. 18B is a cross-sectional view schematically illustrating a state of attachment of the protective cover (No. 2).

FIG. 18C a cross-sectional view schematically illustrating a state of attachment of the protective cover (No. 3).

FIG. 19 is a flowchart illustrating an example of a procedure of protective cover removal processing.

FIG. 20A is a cross-sectional view schematically illustrating a state of removal of the protective cover (No. 1).

FIG. 20B is a cross-sectional view schematically illustrating a state of removal of the protective cover (No. 2).

FIG. 20C is a cross-sectional view schematically illustrating a state of removal of the protective cover (No. 3).

FIG. 21 is a perspective view illustrating an example of appearance of the hand of the robot according to a first modification of the first embodiment.

FIG. 22 is a perspective view illustrating an example of appearance of the hand of the robot according to a second modification of the first embodiment.

FIG. 23 is a cross-sectional view illustrating an example of the hand of the robot according to the second modification of the first embodiment.

FIG. 24A is a diagram schematically illustrating an example of a procedure of attaching the protective covers according to the second modification of the first embodiment (No. 1).

FIG. 24B is a diagram schematically illustrating an example of the procedure of attaching the protective covers according to the second modification of the first embodiment (No. 2).

FIG. 24C is a diagram schematically illustrating an example of the procedure of attaching the protective covers according to the second modification of the first embodiment (No. 3).

FIG. 24D is a diagram schematically illustrating an example of the procedure of attaching the protective covers according to the second modification of the first embodiment (No. 4).

FIG. 25A is a diagram schematically illustrating an example of a procedure of a method of removing the protective covers according to the second modification of the first embodiment (No. 1).

FIG. 25B is a diagram schematically illustrating an example of the procedure of the method of removing the protective covers according to the second modification of the first embodiment (No. 2).

FIG. 25C is a diagram schematically illustrating an example of the procedure of the method of removing the protective covers according to the second modification of the first embodiment (No. 3).

FIG. 26 is a perspective view schematically illustrating an example of a structure of the hand according to a fourth modification of the first embodiment.

FIG. 27 is a diagram illustrating an example of a structure of a reflection-type photosensor.

FIG. 28 is a diagram illustrating an example in which the protective covers are attached to the hand.

FIG. 29 is a diagram illustrating an example of electric contacts provided in a palm part of the hand.

FIG. 30 is a diagram illustrating an example of electric contacts provided in a base plate of the protective cover.

FIG. 31 is a perspective view schematically illustrating an example of the protective cover according to a sixth modification of the first embodiment.

FIG. 32 is a perspective view of a rear side schematically illustrating an example of the protective cover according to the sixth modification of the first embodiment.

FIG. 33 is a perspective view schematically illustrating an example of the structure of the hand according to the sixth modification of the first embodiment.

FIG. 34 is a block diagram schematically illustrating an example of a functional configuration of a robot system according to a second embodiment of the present disclosure.

FIG. 35 is a hardware configuration diagram illustrating an example of a computer achieving functions of the control device.

### DESCRIPTION OF EMBODIMENTS

Embodiments of the present disclosure will now be described in detail hereinafter with reference to drawings. In the following embodiments, the same elements are denoted by the same reference numerals, and an overlapping explanation thereof is omitted.

### First Embodiment

Structure of Robot According to First Embodiment

1. Structure of Robot Main Member

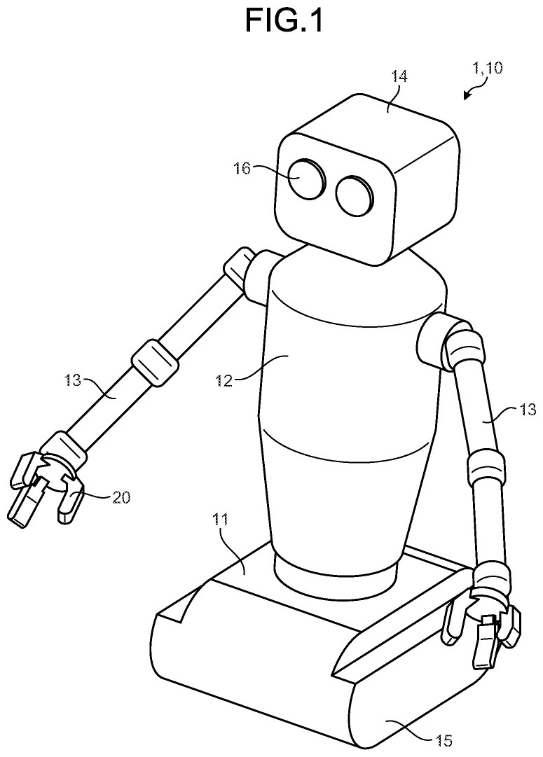

FIG. 1 is a perspective view illustrating an example of appearance of a robot according to a first embodiment of the present disclosure. A robot 1 is, for example, a double arm robot shaped like a human, such as a robot working instead of a human at home, in restaurants, hospitals, or nursing facilities, and a robot working in an industrial environment or an extreme environment. The robot 1 includes a robot main member 10, and a control device (not illustrated). The robot main member 10 includes a base part 11 serving as a base, a body part 12 supported on the base part 11, arms 13 provided on the body part 12, a head part 14 provided on an upper portion of the body part 12, and a moving mechanism 15 provided on a bottom side of the base part 11.

The head part 14 is provided with an imaging unit 16 imaging the front of the robot main member 10. In the robot main member 10, a surface provided with the imaging unit 16 is referred to as “front surface, a surface opposed to the surface provided with the imaging unit 16 is referred to as “rear surface”, and surfaces held between the front surface and the rear surface and located in a direction not being a vertical direction are referred to as “side surface”. Examples of the imaging unit 16 include an optical camera and the like. The imaging unit 16 also has a function corresponding to an attachment check unit checking attachment of a protective cover to the robot main member 10.

The arms 13 are provided on the body part 12. The number of arms 13 may be any number. The example in the drawing illustrates the case where two arms 13 are symmetrically provided on two opposed side surfaces of the body part 12. The arm 13 are, for example, arms having seven degrees of freedom. A distal end of each of the arms 13 is provided with a hand 20 capable of holding a holding object serving as a target. The hand 20 is formed of a metal material or a resin material or the like. The moving mechanism 15 is means for moving the robot main member 10, and formed of wheels or legs.

2. Structure of Hand

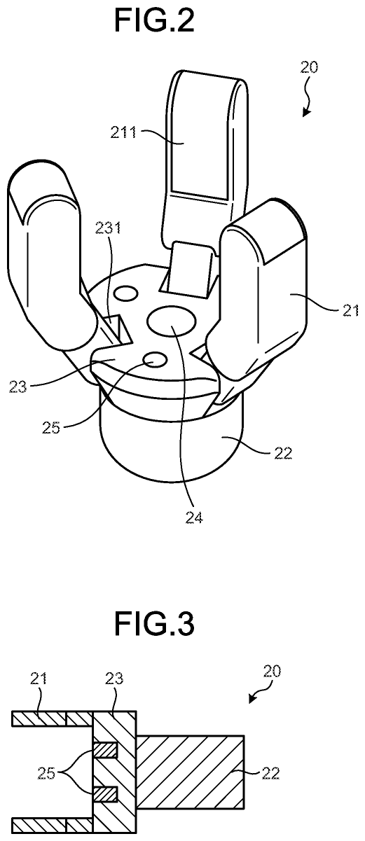

FIG. 2 is a perspective view illustrating an example of appearance of the hand of the robot, and FIG. 3 is a cross-sectional view schematically illustrating an example of the hand. The hand 20 includes fingers 21, a support part 22, a palm part 23, and a position recognition unit 24.

The fingers 21 are supported with the support part 22 rotatably in a direction perpendicular to a surface (hereinafter referred to as “object holding surface”) holding an object. An object holding surface side of each of the fingers 21 is provided with a pressure sensing unit 211 sensing pressure of the held object. The pressure sensing unit 211 is, for example, a force-tactile sensor of a capacitance change type, an electric change type, or an electromagnetic induction type. In addition, a plurality of pressure sensing units 211 are provided over a wide range of the object holding surface such that force distribution in the object holding surface can be sensed. In the example of FIG. 2, the pressure sensing unit 211 is provided to extend from a part around the center of the object holding surface in the height direction to the top part of each of the fingers 21. Each of the fingers 21 includes a plurality of joint portions, for example, like the human's finger. In addition, two or more fingers 21 are supported with the support part 22, but the number of fingers 21 may be any number. FIG. 2 illustrates the case where three fingers 21 are provided. In this case, the fingers 21 are arranged on the support part 22, for example, with intervals of 120°.

A distance sensing unit to recognize a distance between the hand 20 and the held object may be mounted on or on a side of the pressure sensing unit 211 of each of the fingers 21. The distance sensing unit is a proximity sensor of a capacitance change type, an electromagnetic induction type, a magnetic type, or an optical type.

The support part 22 is a part serving as a base of the hand 20. The fingers 21 is attached to the support part 22. The palm part 23 is provided on the bases of the fingers 21 on the support part 22. The palm part 23 has a disk shape provided with cutouts in positions where the fingers 21 are arranged. The palm part 23 is fixed on the support part 22. Joining units 25 to which the protective cover described later is joined are provided in predetermined positions of the palm part 23. The joining units 25 are, for example, electromagnets.

The position recognition unit 24 is provided around the center of the palm part 23. The position recognition unit 24 recognizes an accurate position of the held object held with the hand 20 or the protective cover held with a cover replacement device 50. The position recognition unit 24 is, for example, an imaging unit imaging the held object. Examples of the imaging unit include an optical camera and the like.

3. Structure of Protective Cover

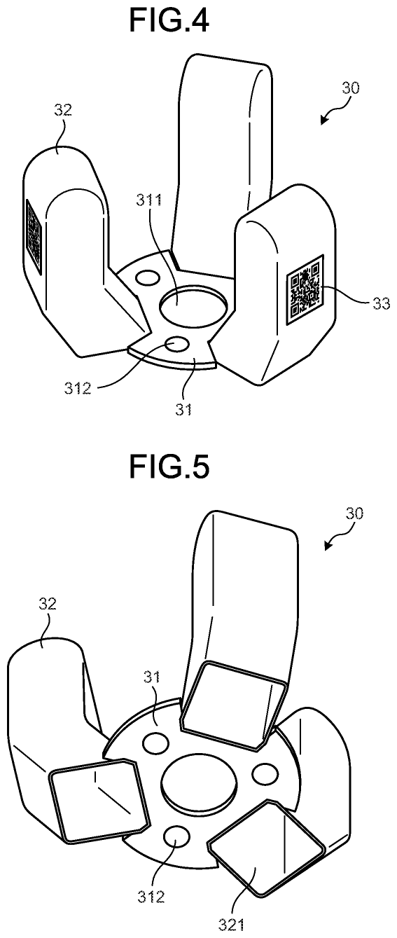

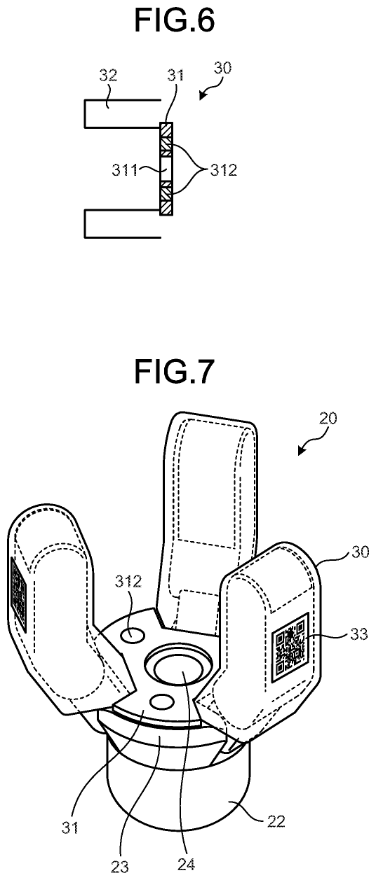

FIG. 4 is a perspective view illustrating an example of a structure of a protective cover attached to the robot according to the first embodiment of the present disclosure. FIG. 5 is a perspective view illustrating an example of the structure of the protective cover attached to the robot according to the first embodiment of the present disclosure, as viewed from a bottom side. FIG. 6 is a cross-sectional view schematically illustrating an example of the protective cover. FIG. 7 is a diagram illustrating appearance of the hand to which the protective cover is attached. A protective cover 30 is a cover attachable to and detachable from part of the surface of the robot main member. This explanation illustrates the case where the protective cover 30 protects the hand 20, as an example. The protective cover 30 includes a base plate 31 and cover parts 32.

The base plate 31 is a part joined to the hand 20. The base plate 31 is preferably formed of a material having rigidity of a certain degree to achieve easy attachment to and detachment from the hand 20. The base plate 31 is formed of, for example, resin or metal. The base plate 31 has substantially the same size as that of the palm part 23 of the hand 20. An opening part 311 is provided around the center of the base plate 31 to avoid obstruction of detection of the position with the position recognition unit 24 of the hand 20. The opening part 311 may be filled with a material transparent for electromagnetic waves of a wavelength used with the position recognition unit 24.

The base plate 31 is also provided with joining units 312. The joining units 312 are provided in positions corresponding to the joining units 25 of the palm part 23 when the protective cover 30 is attached to the hand 20. The joining units 312 are, for example, magnets. Specifically, joining the joining units 312 of the protective cover 30 to the joining units 25 of the hand 20 enables fixation of the protective cover 30 to the hand 20.

The cover parts 32 cover at least the object holding surfaces of the fingers 21. In the example of the drawing, each of the cover parts 32 has a bag-shaped structure covering the whole finger 21, and is provided with an insertion slot 321 into which the finger 21 of the hand 20 is inserted. The cover parts 32 have types according to usages described later. For example, the cover parts 32 are formed of different materials or have different contact properties for the object holding surfaces, according to tasks, such as usages in restaurants, medical sites, nursing sites, and manufacturing factories, or according to held targets even in the same task. The cover parts 32 are preferably formed of an elastic material having relatively low Young's modulus and not obstructing pressure sensing with the pressure sensing unit 211 provided on the hand 20. Examples of such material include a silicone elastomer material, an acrylic elastomer material, and urethane. When the task is a task in restaurants, the cover parts 32 to be used are preferably formed of a silicone elastomer material having high biocompatibility and property hard to deterioration over time.

Each of the cover parts 32 is provided with identification information 33 indicating the type of the cover part 32. The identification information 33 is, for example, a QR code (registered trademark) recording information indicating the type of the cover part 32 including the usage. The identification information 33 is provided on a surface of the cover part 32 on the side not being the object holding surface. This structure enables easy reading of the identification information 33 with, for example, the imaging unit 16 of the head part 14.

4. Structure of Cover Replacement Device

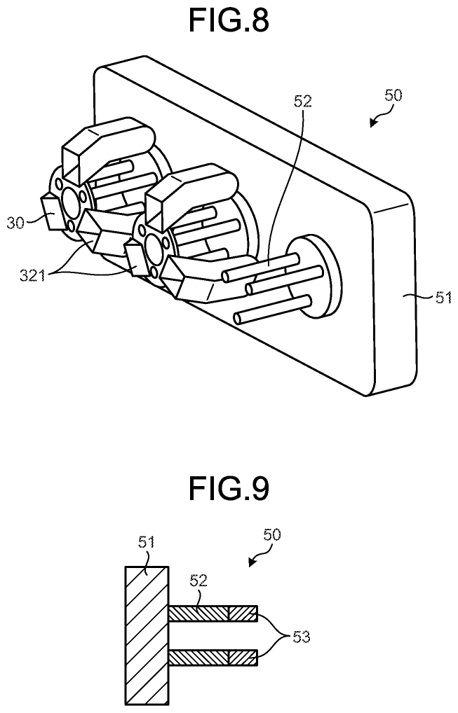

FIG. 8 is a perspective view illustrating an example of a cover replacement device, and FIG. 9 is a cross-sectional view schematically illustrating an example of the cover replacement device. A cover replacement device 50 includes a base 51 attached to, for example, a wall surface in the room, and support portions 52 supporting the protective cover 30. The support portions 52 are, for example, bar-shaped members, and provided to project from the base 51. A distal end of each of the support portions 52 is provided with a joining unit 53. The support portions 52 are provided to be located in the same arrangement positions as the arrangement positions of the joining units 312 provided on the base plate 31 of the protective cover 30. As illustrated in FIG. 8, in a region inside the three cover parts 32, the joining units 53 at the distal ends of the support portions 52 are joined to the joining units 312 of the base plate 31 of the protective cover 30. In this manner, the protective cover 30 is supported with the support portions 52. This structure supports the protective cover 30 in a state in which the insertion slots 321 face outside.

The length of the support portions 52 including the joining units 25 is preferably longer than a distance from the distal end of each of the cover parts 32 covering the fingers 21 in the protective cover 30 to the base plate 31. This structure suppresses contact of the distal end of the protective cover 30 with the base 51 even when the protective cover 30 is supported with the cover replacement device 50, and cleanliness thereof is maintained.

5. Structure of Control Device of Robot

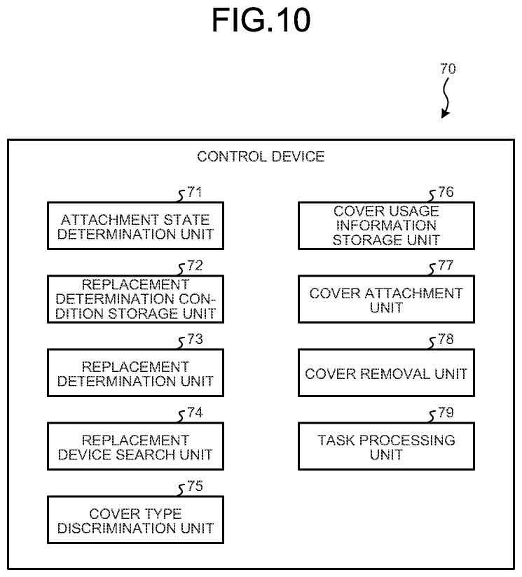

FIG. 10 is a block diagram illustrating an example of a functional configuration of the control device of the robot according to the first embodiment of the present disclosure. A control device 70 controls operations of the robot main member 10. Only functions relating to replacement of the protective cover 30 of the hand 20 of the robot main member 10 are illustrated herein. The control device 70 may be provided on the robot main member 10, or is not required to be provided on the robot main member 10. When the control device 70 is not provided on the robot main member 10, the control device 70 and the robot main member 10 are connected by, for example, wireless communications. The control device 70 includes an attachment state determination unit 71, a replacement determination condition storage unit 72, a replacement determination unit 73, a replacement device search unit 74, a cover type discrimination unit 75, a cover usage information storage unit 76, a cover attachment unit 77, a cover removal unit 78, and a task processing unit 79.

The attachment state determination unit 71 determines whether the protective cover 30 is attached to part of the robot main member 10, and checks the type of the attached protective cover 30 when the protective cover 30 is attached. In this example, the attachment state determination unit 71 determines whether the protective cover 30 is attached to the hand 20 of the robot main member 10. The attachment state determination unit 71 determines presence/absence of the attachment state of the protective cover 30, on the basis of information acquired by reading a predetermined position of the hand 20 with the imaging unit 16 of the head part 14. Specifically, the attachment state determination unit 71 determines presence/absence of attachment of the protective cover 30, on the basis of whether the identification information 33 provided on the predetermined position of the protective cover 30 can be read with the camera. When the identification information 33 can be read, the attachment state determination unit 71 acquires the type of the protective cover 30 from the read identification information 33.

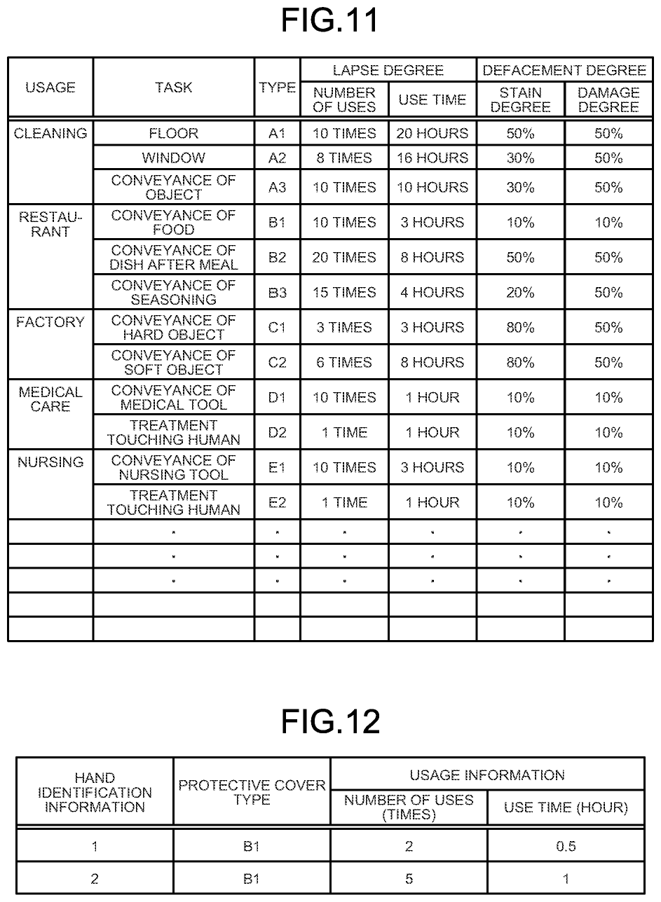

The replacement determination condition storage unit 72 stores therein replacement determination conditions to determine whether replacement of the protective cover 30 is required. The replacement determination conditions are determination standards provided for each of usages of the robot 1. FIG. 11 is a diagram illustrating an example of replacement determination conditions according to the first embodiment. The replacement determination conditions are provided for each of types of the protective cover 30. The types of the protective cover 30 are provided according to, for example, tasks in usages. The usages include, for example, the environment in which the robot 1 works and the target on which the robot 1 works. Examples of the usages include cleaning, work in restaurants, work in factories, work in medical sites, and work in nursing. Each of the usages includes one or more tasks. For example, when the usage is “cleaning”, items “floor”, “window”, and “conveyance of object” and the like are illustrated as tasks. For example, the type of the protective cover 30 is provided for each of the tasks.

Examples of the replacement determination conditions provided for each of the types of the protective cover 30 include lapse degree and defacement degree. The lapse degree is information indicating how much time has lapsed since the protective cover 30 was attached to the robot main member 10. Examples of the lapse degree include the number of uses and use time. Examples of the defacement degree include stain degree being the degree of a stain of the protective cover 30 attached to the robot main member 10, and damage degree indicating the degree of damage of the protective cover 30. The stain degree is defined using, for example, the rate of the stained portions for the whole surface of the protective cover 30 and the thickness of the stain of the most stained portion in the protective cover 30. The damage degree is defined using, for example, the rate of damages for the whole surface of the protective cover 30 and existence of a scratch piercing the thickness of the protective cover 30.

The replacement determination unit 73 determines the timing to replace the protective cover 30 in accordance with the replacement determination conditions corresponding to the usage of the robot 1. When the attachment state determination unit 71 determines that the protective cover 30 is attached, the replacement determination unit 73 acquires the replacement determination conditions corresponding to the type of the attached protective cover 30 from the replacement determination condition storage unit 72, and determines whether the current time is the timing to replace the protective cover 30. The replacement determination unit 73 determines the replacement timing, for example, on the basis of whether the protective cover 30 is the protective cover of the type suitable for the task, and whether the lapse degree and the defacement degree of the protective cover 30 satisfy the replacement determination conditions. Suppose that the task is instructed in advance by the manager of the robot 1.

The replacement device search unit 74 searches for the cover replacement device 50 in the vicinity of the robot main member 10, when the replacement determination unit 73 determines that replacement of the protective cover 30 is required. In searching, the replacement device search unit 74 recognizes existence of the cover replacement device 50 using image data imaged with the imaging unit 16 provided on the head part 14 of the robot main member 10. When the cover replacement device 50 is positioned in the vicinity, the robot main member 10 is moved to the vicinity of the cover replacement device 50. By contrast, when no cover replacement device 50 exists in the vicinity, the replacement device search unit 74 transmits a signal indicating that replacement of the protective cover 30 is impossible to, for example, the manager of the robot 1.

The cover usage information storage unit 76 stores therein cover usage information indicating the use state of the protective cover 30 attached to the robot main member 10. Examples of the cover usage information include the lapse degree of the protective cover 30. The lapse degree includes the number of uses and the use time since attachment of the protective cover 30 to the robot main member 10. FIG. 12 is a diagram illustrating an example of cover usage information. The cover usage information includes hand identification information, the protective cover type, and usage information. The hand identification information is information to distinguish the hands from each other, when two hands 20 are provided on one robot main member 10 as illustrated in FIG. 1. Because this example illustrates the case where the protective cover 30 is attached to the hand 20, the hand identification information is used. In the case of attaching the protective cover 30 also to other parts, identification information is provided for each of the parts. The protective cover type indicates the type of the protective cover 30 attached to the hand 20. For example, the types of the protective cover 30 included in the replacement determination conditions in FIG. 11 are used. The usage information includes the number of uses and the use time since attachment of the protective cover 30.

The cover type discrimination unit 75 discriminates the type of the protective cover 30 supported with the cover replacement device 50, and determines whether the protective cover 30 of the type corresponding to the execution-instructed task exists on the cover replacement device 50. Specifically, the cover type discrimination unit 75 images the identification information 33 of the protective cover 30 supported on the cover replacement device 50 with the imaging unit 16 provided on the head part 14 of the robot main member 10, and discriminates the type of the protective cover 30. The cover type discrimination unit 75 also determines whether a protective cover 30 corresponding to the execution-instructed task exists in the types of the determined protective covers 30.

The cover attachment unit 77 controls attachment of the protective cover 30 of the target type to the hand 20, when no protective cover 30 is attached to the robot main member 10 and the protective cover 30 of the target type exists in the cover replacement device 50. In attachment of the protective cover 30 to the hand 20, the cover attachment unit 77 accurately recognizes the position of the protective cover 30 serving as the target using the image data imaged with the position recognition unit 24 provided on the hand 20, and joins the protective cover 30 to the hand 20 while adjusting the position of the arm 13 to an optimum position. Specifically, the cover attachment unit 77 controls the positions of the hand 20 and the arm 13 such that the position of the joining units 25 of the hand 20 agree with the positions of the joining units 312 of the protective cover 30, and brings the joining units 25 of the hand 20 into contact with the joining units 312 of the protective cover 30. When the joining units 25 contact the joining units 312 of the protective cover 30, the cover attachment unit 77 turns on the electromagnets of the joining units 25 to be joined to the protective cover 30, and separates the protective cover 30 from the support portions 52 of the cover replacement device 50. In this operation, the electromagnets of the joining units 53 of the cover replacement device 50 are turned off.

The cover removal unit 78 removes the protective cover 30 attached to the robot main member 10, when the protective cover 30 is attached to the robot main member 10 and the replacement determination unit 73 determines that replacement of the protective cover 30 is required. In removal of the protective cover 30, the cover removal unit 78 accurately recognizes the target positions of the support portions 52 of the cover replacement device 50 using image data imaged with the position recognition unit 24 provided on the hand 20, and joins the protective cover 30 attached to the hand 20 to the support portions 52 while adjusting the position of the arm 13 to an optimum position. Specifically, the cover removal unit 78 controls the positions of the hand 20 and the arm 13 such that the positions of the joining units 25 of the hand 20 agree with the positions of the joining units 53 of the cover replacement device 50, and brings the joining units 25 of the hand 20 into contact with the joining units 53 of the cover replacement device 50. When the joining units 312 of the protective cover 30 contact the joining units 53 of the cover replacement device 50, the cover removal unit 78 turns off the electromagnets of the joining units 25 of the hand 20, and separates the joining units 25 from the protective cover 30. In this operation, the electromagnets of the joining units 53 of the cover replacement device 50 are turned on.

The cover attachment unit 77 and the cover removal unit 78 correspond to a cover replacement unit controlling processing of replacing the protective cover 30 with the robot main member 10 in accordance with a result of determination of the timing to replace the protective cover 30 in the replacement determination unit 73.

The task processing unit 79 causes the robot main member 10 to execute processing according to the execution-instructed task, when the protective cover 30 of the type corresponding to the execution-instructed task is attached to the robot main member 10. When the task is executed, the task processing unit 79 records the number of uses in the cover usage information storage unit 76. The task processing unit 79 also records the use time since attachment of the protective cover 30 at a predetermined timing.

Procedure of Processing of Attachment and Detachment of Protective Cover According to First Embodiment

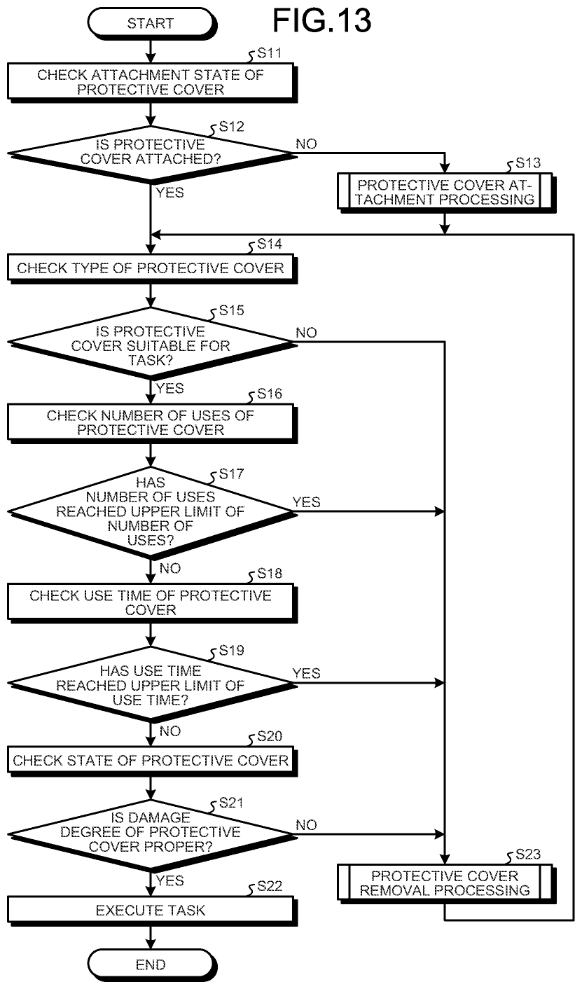

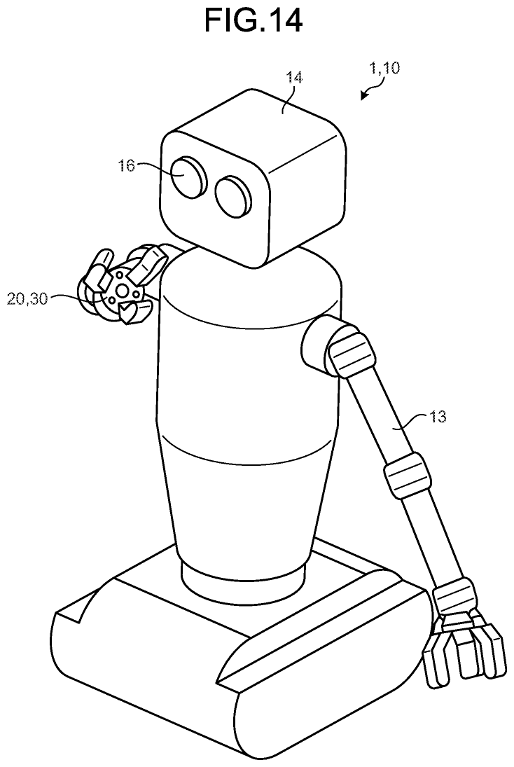

FIG. 13 is a flowchart illustrating an example of a procedure of processing of attachment and removal of protective cover according to the first embodiment of the present disclosure. This explanation illustrates the case where the robot main member 10 works with the protective cover 30 attached to the hand 20. First, the attachment state determination unit 71 of the control device 70 checks the attachment state of the protective cover 30 on receipt of a task execution instruction, as an example (Step S11). FIG. 14 is a diagram schematically illustrating an example of a state of checking an attachment state of the protective cover in the robot. As illustrated in FIG. 14, the attachment state determination unit 71 checks presence/absence of identification information 33 provided on the protective cover 30 by imaging, for example, the predetermined position of the hand 20 with the imaging unit 16 provided on the head part 14 of the robot main member 10. When the protective cover 30 is attached to the hand 20, identification information 33 exists in the predetermined position of the hand 20. Specifically, the hand 20 is in a state in which the protective cover 30 is attached thereto when identification information 33 exists, and the hand 20 is in a state in which no protective cover 30 is attached thereto when no identification information 33 exists.

On the basis of the checking result, the attachment state determination unit 71 determines whether any protective cover 30 is attached (Step S12). When no protective cover 30 is attached (No at Step S12), the replacement determination unit 73 executes protective cover attachment processing of instructing the cover attachment unit 77 to attach the cover of the type corresponding to the type of the task (Step S13).

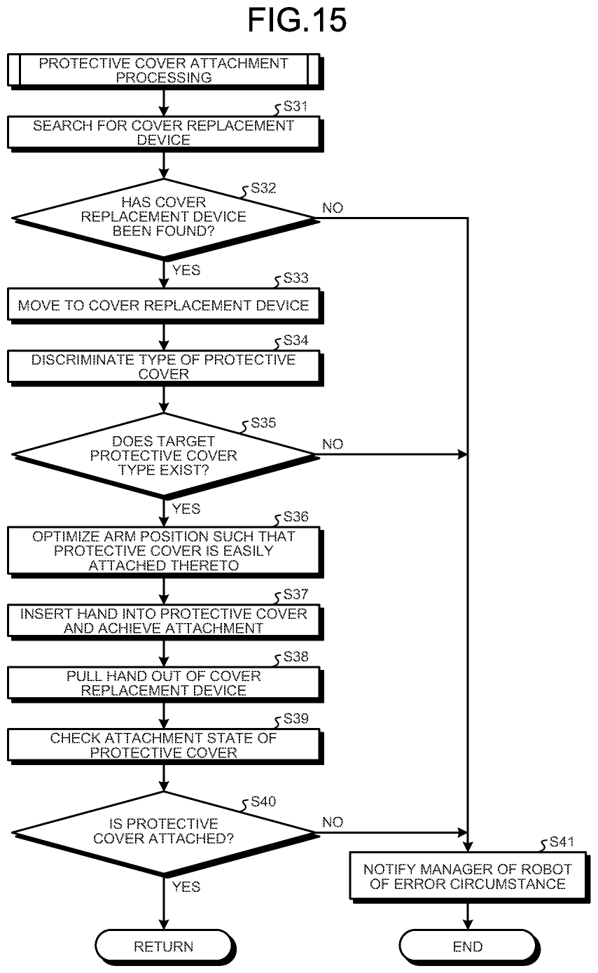

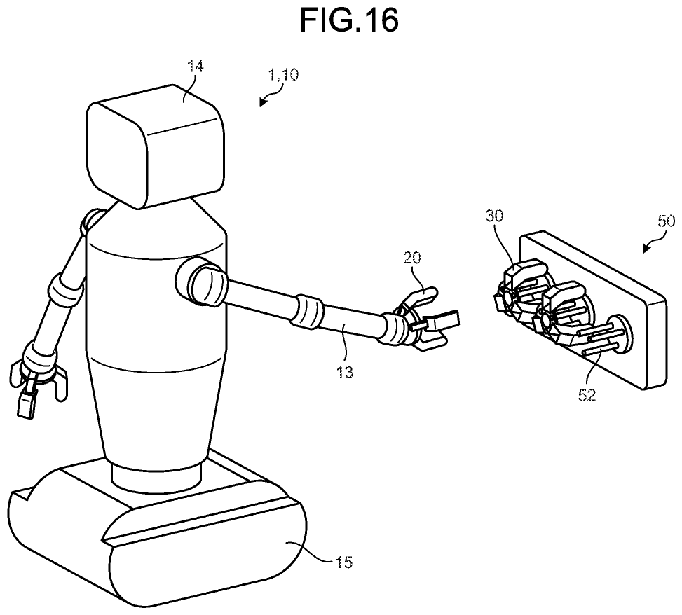

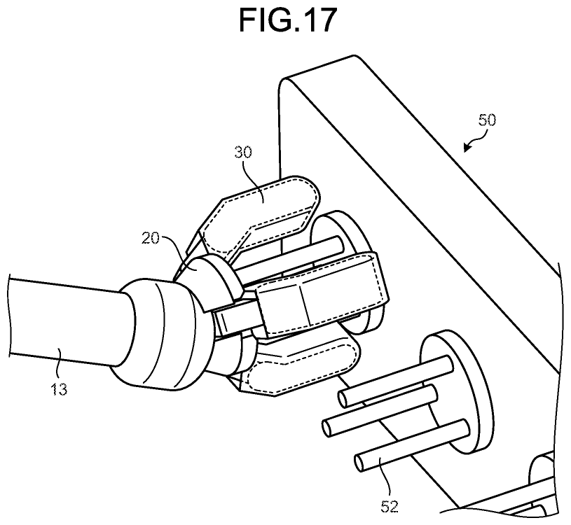

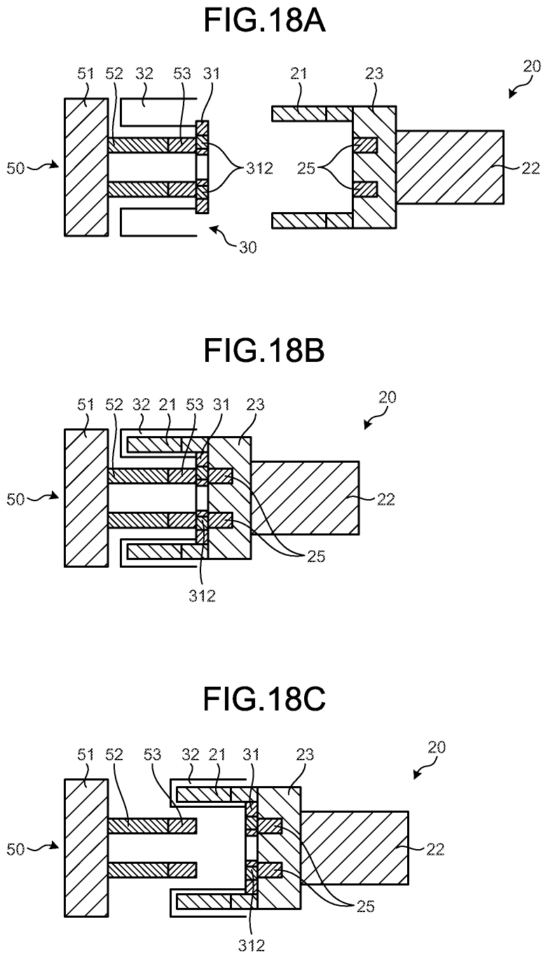

FIG. 15 is a flowchart illustrating an example of a procedure of protective cover attachment processing according to the first embodiment. FIG. 16 is a perspective view schematically illustrating a state in which the robot approaches the protective cover of the cover replacement device, and FIG. 17 is a diagram schematically illustrating a state in which the hand of the robot is attached to the protective cover of the cover replacement device. FIG. 18A to FIG. 18C are cross-sectional views schematically illustrating a state of attachment of the protective cover. FIG. 18A to FIG. 18C are diagrams for clearly explaining the state of attachment of the protective cover 30.

First, the replacement device search unit 74 of the control device 70 searches for the cover replacement device 50 (Step S31). For example, the replacement device search unit 74 images the surrounding region with the imaging unit 16 provided on the head part 14 of the robot main member 10, and searches whether the cover replacement device 50 exists using an image processing technique. On the basis of a result of the search, the replacement device search unit 74 determines whether the cover replacement device 50 has been found (Step S32).

When the cover replacement device 50 has been found (Yes at Step S32), the replacement device search unit 74 moves the robot main member 10 to the cover replacement device 50 (Step S33). For example, the replacement device search unit 74 provides the moving mechanism 15 with an instruction to move in a direction in which the cover replacement device 50 has been found, to move the robot main member 10.

When the robot main member 10 arrives at the position of the cover replacement device 50, the cover type discrimination unit 75 discriminates the type of the protective cover 30 supported on the cover replacement device 50 (Step S34). For example, the cover type discrimination unit 75 images the protective cover 30 supported on the cover replacement device 50, with the imaging unit 16 provided on the head part 14. In this operation, a region including the identification information 33 of the protective cover 30 is imaged with the camera. Thereafter, the cover type discrimination unit 75 acquires the identification information 33 from the imaged image data, and discriminates the type of the protective cover 30 from the identification information 33. In this example, suppose that the identification information 33 is information indicating the type of the protective cover 30.

On the basis of a result of the discrimination, the cover type discrimination unit 75 determines whether the protective cover 30 of the target type exists in the cover replacement device 50 (Step S35). When the protective cover 30 of the target type exists in the cover replacement device 50 (Yes at Step S35), the cover attachment unit 77 optimizes the position of the arm 13 such that the protective cover 30 is easily attached thereto (Step S36). For example, as illustrated in FIG. 16 and FIG. 18A, using the position recognition unit 24 provided on the hand 20, the cover attachment unit 77 optimizes the position of the arm 13 such that the positions of the joining unit 312 of the protective cover 30 of the target type in the cover replacement device 50 agree with the positions of the joining units 25 of the hand 20. When the position recognition unit 24 is, for example, a camera, the position of the arm 13 is optimized using imaging data. The cover replacement device 50 is in the state in which the protective cover 30 is fixed on the support portions 52. In this state, the electromagnets of the joining units 53 at the distal ends of the support portions 52 are in the on-state, and joined to the magnets serving as the joining units 312 of the protective cover 30 by magnetic force. The position recognition unit 24 controls the position of the arm 13 such that the position of the joining units 25 of the hand 20 agree with the positions of the joining units 312 of the protective cover 30.

Thereafter, as illustrated in FIG. 17, while the position of the arm 13 is maintained with the cover attachment unit 77, the hand 20 is inserted into the protective cover 30 serving as the target, and attachment is achieved (Step S37). Specifically, as illustrated in FIG. 18B, when the joining units 25 of the hand 20 contacts the joining units 312 of the protective cover 30 supported with the cover replacement device 50, the electromagnets of the joining units 25 of the hand 20 are turned on, and the electromagnets of the joining units 53 of the cover replacement device 50 are turned off. In this manner, the protective cover 30 is magnetically separated from the support portions 52 of the cover replacement device 50, and changed to a state of being joined to the hand 20.

Thereafter, the hand 20 is pulled out of the cover replacement device 50 with the cover attachment unit 77 (Step S38). Specifically, as illustrated in FIG. 18C, the hand 20 moves away from the cover replacement device 50, in a state in which the protective cover 30 is attached to the hand 20. Thereafter, the attachment state determination unit 71 checks the attachment state of the protective cover 30 (Step S39). In this operation, the processing similar to the processing explained at Step S11 is executed.

As a result of the checking, the attachment state determination unit 71 determines whether the protective cover 30 is attached to the hand 20 of the robot main member 10 (Step S40). When the protective cover 30 is attached to the hand 20 of the robot main member 10 (Yes at Step S40), the processing returns to FIG. 13.

When no cover replacement device 50 has been found at Step S32 (No at Step S32), when no protective cover 30 of the target type exists in the cover replacement device 50 at Step S35 (No at Step S35), or when no protective cover 30 is attached to the hand 20 of the robot main member 10 at Step S40 (No at Step S40), an error is notified to the manager of the robot 1, for example (Step S41). Thereafter, the protective cover attachment processing is ended.

With reference to FIG. 13 again, when the protective cover attachment processing at Step S13 is ended, or when the protective cover 30 is attached at Step S12 (Yes at Step S12), the attachment state determination unit 71 reads the identification information 33 of the protective cover 30 imaged at Step S11 or Step S40. Thereafter, the attachment state determination unit 71 checks the type of the protective cover 30 attached to the hand 20 (Step S14). The attachment state determination unit 71 transmits the read identification information 33 to the replacement determination unit 73.

The replacement determination unit 73 determines using the replacement determination conditions whether the type of the attached protective cover 30 is the protective cover 30 suitable for an instruction of the execution-instructed task (Step S15). For example, the replacement determination unit 73 acquires the type of the protective cover 30 corresponding to the execution-instructed task from the replacement determination conditions in the replacement determination condition storage unit 72. Thereafter, the replacement determination unit 73 determines whether the attached protective cover 30 is the protective cover 30 suitable for the instruction of the task, on the basis of whether the acquired type agrees with the read identification information 33.

When the protective cover is the protective cover 30 suitable for the task (Yes at Step S15), the replacement determination unit 73 checks the number of uses of the attached protective cover 30 acquired from the cover usage information (Step S16). Thereafter, the replacement determination unit 73 determines whether the number of uses of the attached protective cover 30 has reached the number of uses corresponding to the execution-instructed task and acquired from the replacement determination condition storage unit 72 (Step S17). Specifically, because the replacement determination condition stored in the replacement determination condition storage unit 72 serves as the upper limit value at the time when the protective cover 30 is replaced, the replacement determination unit 73 determines whether the attached protective cover 30 has reached the upper limit of the number of uses.

When the number of uses of the attached protective cover 30 has not reached the upper limit of the number of uses (No at Step S17), the replacement determination unit 73 checks the use time of the attached protective cover 30 acquired from the cover usage information (Step S18). Thereafter, the replacement determination unit 73 determines whether the use time of the attached protective cover 30 has reached the use time corresponding to the execution-instructed task and acquired from the replacement determination condition storage unit 72 (Step S19). Specifically, the replacement determination unit 73 determines whether the attached protective cover 30 has reached the upper limit of the use time.

When the use time of the attached protective cover 30 has not reached the upper limit of the use time (No at Step S19), the replacement determination unit 73 checks the state of the protective cover 30 (Step S20). In this operation, the replacement determination unit 73 images the protective cover 30 attached to the hand 20 with the imaging unit 16 provided on the head part 14, and checks the defacement degree of the protective cover 30 using the imaged image data. As the defacement degree, the replacement determination unit 73 checks the stain degree and the damage state of the protective cover 30. For example, when the rate of the stained regions of the protective cover 30 is equal to or smaller than a predetermined value, or when the protective cover 30 includes no scratches piercing the protective cover 30 in the thickness direction, the replacement determination unit 73 determines that the defacement degree is proper.

The replacement determination unit 73 determines whether the defacement degree of the protective cover 30 is proper (Step S21). When the defacement degree of the protective cover 30 is proper (Yes at Step S21), the task processing unit 79 executes the instructed task with the robot main member 10 (Step S22). After execution of the task, the task processing unit 79 updates the number of uses and the use time in the cover usage information storage unit 76. The processing is ended as described above.

When the protective cover 30 is not the protective cover 30 suitable for the task at Step S15 (No at Step S15), when the number of uses of the attached protective cover 30 has reached the upper limit of the number of uses at Step S17 (Yes at Step S17), when the use time of the attached protective cover 30 has reached the upper limit of the use time at Step S19 (Yes at Step S19), or when the defacement degree of the protective cover 30 is not proper at Step S21 (No at Step S21), protective cover removal processing is executed (Step S23).

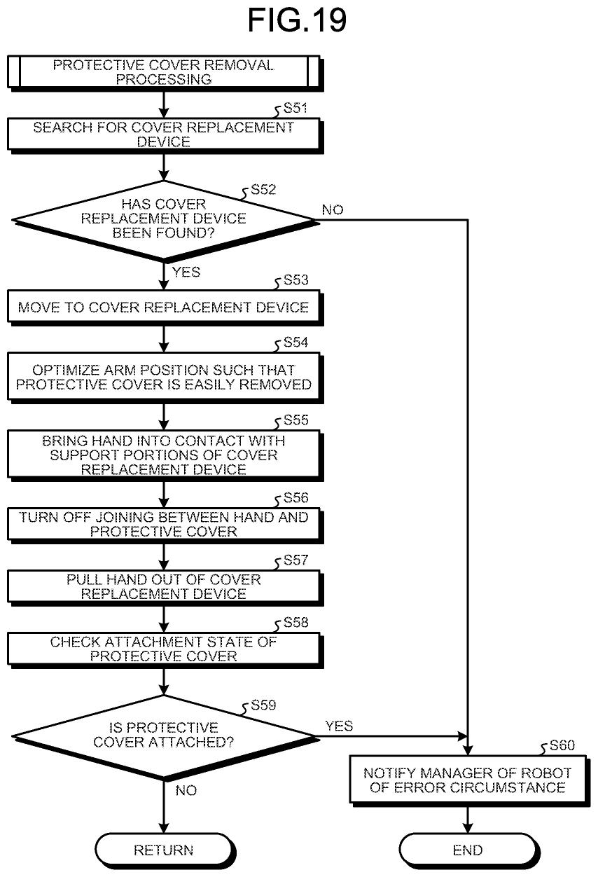

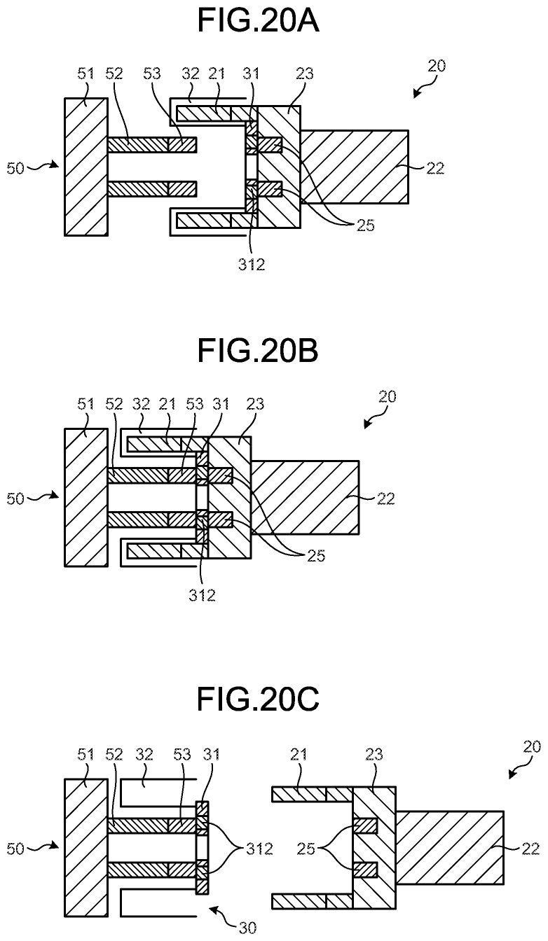

FIG. 19 is a flowchart illustrating an example of a procedure of the protective cover removal processing. FIG. 20A to FIG. 20C are cross-sectional views schematically illustrating a state of removal of the protective cover. FIG. 20A to FIG. 20C are diagrams for clearly explaining the state of removal of the protective cover 30. Also in the protective cover removal processing, in the same manner as Steps S31 to S33 of the protective cover attachment processing in FIG. 15, the replacement device search unit 74 of the control device 70 searches for the cover replacement device 50, and the robot main member 10 is moved to the cover replacement device 50 when the cover replacement device 50 has been found (Steps S51 to S53).

Thereafter, the cover removal unit 78 optimizes the position of the arm 13 such that the protective cover 30 is easily attached thereto (Step S54). For example, as illustrated in FIG. 20A, the cover removal unit 78 sets the support portions 52 supporting no protective cover 30 in the cover replacement device 50 to a position to remove the protective cover 30, using the position recognition unit 24 provided on the hand 20 of the robot main member 10. In addition, the cover removal unit 78 optimizes the position of the arm 13 such that the positions of the joining units 53 of the cover replacement device 50 agree with the positions of the joining units 25 of the hand 20. When the position recognition unit 24 is, for example, a camera, the position of the arm 13 is optimized using image data. While this state is maintained, the hand 20 is brought close to the cover replacement device 50. Because no protective cover 30 is supported with the support portions 52 serving as the target in the cover replacement device 50, the electromagnets of the joining units 53 at the distal ends thereof are in the off state.

Thereafter, as illustrated in FIG. 20B, the cover removal unit 78 brings the hand 20 into contact with the support portions 52 serving as the target, while the position of the arm 13 is maintained (Step S55). Specifically, the cover removal unit 78 brings the joining units 312 of the protective cover 30 into contact with the joining units 53 of the support portions 52 of the cover replacement device 50. Thereafter, as illustrated in FIG. 20C, joining between the hand 20 and the protective cover 30 is turned off (Step S56). Specifically, the electromagnets of the joining units 25 of the hand 20 are turned off, and the electromagnets of the joining units 53 of the support portions 52 of the cover replacement device 50 are turned on. In this manner, the protective cover 30 is magnetically separated from the hand 20, and changes to a state of being joined to the support portions 52 of the cover replacement device 50.

Thereafter, the cover attachment unit 77 pulls the hand 20 out of the cover replacement device 50 (Step S57). Specifically, in the state in which the protective cover 30 is supported with the support portions 52 of the cover replacement device 50, the hand 20 is pulled out of the protective cover 30.

This example illustrates the case where the protective cover 30 is joined to the support portions 52 of the cover replacement device 50 by magnetic force and the protective cover 30 is removed by turning off the magnetic force between the hand 20 and the protective cover 30, but the embodiment is not limited thereto. The protective cover 30 may be removed from the hand 20 using external force when the hand 20 with the attached protective cover 30 is brought into contact with the support portions 52 of the cover replacement device 50. For example, the cover replacement device 50 is provided with a protective cover holder on which part of the protective cover 30 is hooked and held, and the protective cover 30 can be removed by pulling out the hand 20 in the state in which the protective cover 30 is held with the protective cover holder. This structure removes the necessity for controlling the timing to turn on/off the electromagnets between the hand 20 of the robot main member 10 and the support portions 52 of the cover replacement device 50 as in the case of using electromagnets. This structure enables use of magnets, not electromagnets, as the joining units 25 and 53 in the hand 20 and the cover replacement device 50.

Thereafter, the attachment state determination unit 71 checks the attachment state of the protective cover 30 (Step S58). In this operation, processing similar to the processing explained at Step S11 is executed. On the basis of a result of the checking, the attachment state determination unit 71 determines whether the protective cover 30 is attached to the hand 20 of the robot main member 10 (Step S59). When no protective cover 30 is attached to the hand 20 of the robot main member 10 (No at Step S59), because the protective cover 30 has been normally removed, the processing returns to FIG. 13.

When no cover replacement device 50 has been found at Step S52 (No at Step S52) or when the protective cover 30 is attached to the hand 20 of the robot main member 10 at Step S59 (Yes at Step S59), an error is notified to the manager of the robot 1 or the like (Step S60). Thereafter, the protective cover removal processing is ended.

As illustrated in FIG. 1, when a plurality of places to each of which the protective cover 30 is attached exist in the robot main member 10, for example, determination of replacement can be performed for each of the places. In this case, there are cases where the protective cover 30 is not replaced in one place and the protective cover 30 is replaced in another place. As another example, when any one place requiring replacement exists in the robot main member 10, the protective covers 30 of all the places may be replaced together. In this case, the replacement determination conditions change. Specifically, in a certain place, the protective cover 30 is replaced although the replacement determination conditions are not satisfied. For example, such a replacement method is applied to the case where work touching a human body is executed in a medical site or a nursing site.

The protective cover 30 may be replaced according to the gender and/or the age of the facing person, for example, in the robot 1 helping with housework, as the usages in addition to the usages illustrated in FIG. 11.

The explanation described above illustrates the case where the protective cover 30 is attached to the hand 20 as an example, but the present embodiment is not limited thereto. For example, the present embodiment is generally applicable to the cases where the protective cover 30 is attached to the robot main member 10, such as the case where a cap-like protective cover 30 is attached to the head part 14 of the robot main member 10 and the case where an apron-like protective cover 30 is attached to the body part 12.

In the first embodiment, in the state in which the protective cover 30 is attached to the robot main member 10, for example, when a task execution instruction is received, the control device 70 determines whether the attached protective cover 30 satisfies the cover replacement conditions. When the cover replacement conditions are satisfied, the control device 70 determines that the current time is the timing to replace the protective cover 30, and executes processing of replacing the protective cover 30. This structure enables the robot 1 to autonomously replace the protective cover 30.

In addition, the usages are provided with the types of tasks executed with the robot 1, and the timing to replace the protective cover 30 using the determination standards corresponding to the type of the task. This structure enables change of the determination standards for replacement of the protective cover 30 according to the executed task even in the same usage. For example, in the robot 1 used in a restaurant, when the task is carrying dishes after a meal, no problem occurs even if the protective cover 30 is stained to a certain degree. However, when the robot 1 carries food to the customer, there are cases where it is desirable that the protective cover 30 is not stained. As described above, instead of uniformly executing determination regardless of the task, this structure enables fine replacement of the protective cover 30 depending on the situation in which the robot 1 is used.

As another example, the determination standards for executing replacement may be changed according to the type of the protective cover 30 to be used, not the type of the task. For example, the determination standards for executing replacement differ between the case where the protective cover 30 includes the cover parts 32 formed of a thick material and the case where the protective cover 30 includes the cover parts 32 formed of a thin material, even when the same work is executed. As described above, the timing to execute replacement can be set minutely according to the type of the protective cover 30.

In addition, the timing to replace the protective cover 30 is determined using the type of the protective cover 30 determined for each of the tasks and the lapse degree since attachment of the protective cover 30 as the determination standards. With this structure, the number of times and the use time at which the protective cover 30 should be replaced are uniformly determined for each of the types of the protective cover 30. This structure enables replacement of the protective cover 30 before the hand 20 or the held target is stained, even when determination of the timing to execute replacement is difficult from the appearance of the protective cover 30, for example.

The attachment check unit checks presence/absence of attachment of the protective cover 30 to the robot main member 10, and the attachment state determination unit 71 of the control device 70 determines presence/absence of attachment of the protective cover 30 acquired from a result of checking with the attachment check unit and acquires the type of the protective cover 30. In addition, the replacement determination unit 73 determines whether replacement of the protective cover 30 is required. This structure enables autonomous acquisition of the attachment state of the protective cover 30 attached to the robot main member 10 and the type of the protective cover 30 when the protective cover 30 is attached, and autonomous determination of the timing to execute replacement.

When the attachment state determination unit 71 determines that no protective cover is attached, the replacement determination unit 73 instructs the cover removal unit 78 and the cover attachment unit 77 to attach the protective cover corresponding to the execution-instructed task. This structure enables autonomous determination of presence/absence of attachment of the protective cover 30 and autonomous attachment of the protective cover 30 corresponding to the task to the robot main member 10.

When the attachment check unit is the imaging unit 16, the attachment check unit images the protective cover 30, and the attachment state determination unit 71 determines presence/absence of attachment of the protective cover 30 and the type of the attached protective cover 30. Providing the protective cover 30 with information recognizable with imaged image data enables determination of the type of the protective cover 30 with the imaged image data.

The replacement determination unit 73 determines the defacement degree of the protective cover 30 using image data imaged with the imaging unit 16. This structure enables autonomous determination of the timing to replace the protective cover 30 in view of the stain degree or the damage degree of the protective cover 30.

The hand 20 of the robot main member 10 and the protective cover 30 are configured to be joined via the joining units 25 and 312. This structure enables easy attachment of the protective cover 30 to the hand 20 by joining the joining units 25 and 312, and easy removal of the protective cover 30 by separating the joining units 25 and 312. In particular, when the joining units 25 of the hand 20 are electromagnets and the joining units 312 of the protective cover 30 are magnets, joining and separation between the joining units 25 and 312 can be easily executed by turning on and off the electromagnets. This structure provides the protective cover 30 easily attachable to and detachable from the hand 20.

### First Modification of First Embodiment

The first embodiment illustrates the case where the joining units 25 of the hand 20 are formed of electromagnets and the joining units 312 of the protective cover 30 are formed of magnets, but the embodiment is not limited thereto. FIG. 21 is a perspective view illustrating an example of appearance of the hand of the robot according to a first modification of the first embodiment. The following explanation illustrates only parts different from those of the first embodiment. Each of the joining units 25 of the palm part 23 is formed of a gas hole 251, a gas pipe 252, and a gas intake/outlet (not illustrated). The gas hole 251 is one end portion of the gas pipe 252. The other end portion of the gas pipe 252 is provided with the gas intake/outlet. The gas intake/outlet takes the air (gas) into the gas hole 251 and blows off the gas out of the gas hole 251. The gas intake/outlet is provided on, for example, the arm 13 and/or the body part 12 of the robot main member 10. The air, nitrogen gas, or Ar gas or the like may be used as the gas.

In the hand 20 as described above, in the state in which the hand 20 is inserted into the protective cover 30 and the palm part 23 of the hand 20 is in contact with the base plate 31 of the protective cover 30, the air is taken into the gas holes 251. In this manner, the protective cover 30 is joined to the hand 20. In this case, the protective cover 30 may be simply supported with the support portions 52 of the cover replacement device 50.

In addition, in the hand 20 to which the protective cover 30 is attached, the robot main member 10 is moved to a predetermined position to remove the protective cover 30, the hand 20 is set to, for example, a state facing downward, and the gas is blown out of the gas holes 251. In this manner, the protective cover 30 can be removed.

In the first modification of the first embodiment, the protective cover 30 is joined to the hand 20 by taking the air into the gas holes 251 provided on the hand 20 of the robot main member 10. This structure enables the robot main member 10 to work even in an environment in which no magnets can be used.

### Second Modification of First Embodiment

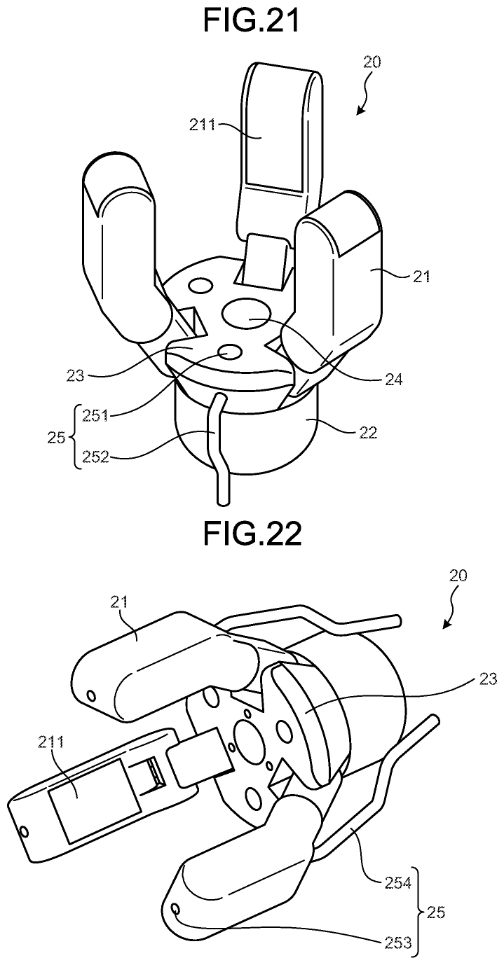

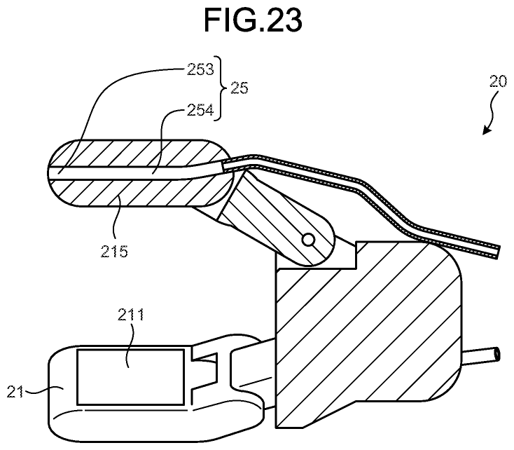

FIG. 22 is a perspective view illustrating an example of appearance of the hand of the robot according to a second modification of the first embodiment, and FIG. 23 is a cross-sectional view illustrating an example of the hand of the robot according to the second modification of the first embodiment. The following explanation illustrates only parts different from those of the first embodiment and the first modification. In the first modification, the gas holes 251 serving as the joining units 25 are provided in the palm part 23. In the second modification, gas holes 253 are provided at distal end portions of the fingers 21. Each of the gas holes 253 is one end of a gas pipe 254. The gas pipe 254 may be drawn to the outside in the middle of the finger 21, as illustrated in the drawing. In the example in the drawing, the gas pipe 254 has a structure of being provided inside the finger 21 in a distal end portion beyond the first joint of the finger 21, and drawn to the outside around the first joint. The other end of the gas pipe 254 is provided with a gas outlet (not illustrated). The air, nitrogen gas, or Ar gas or the like may be used as the gas.

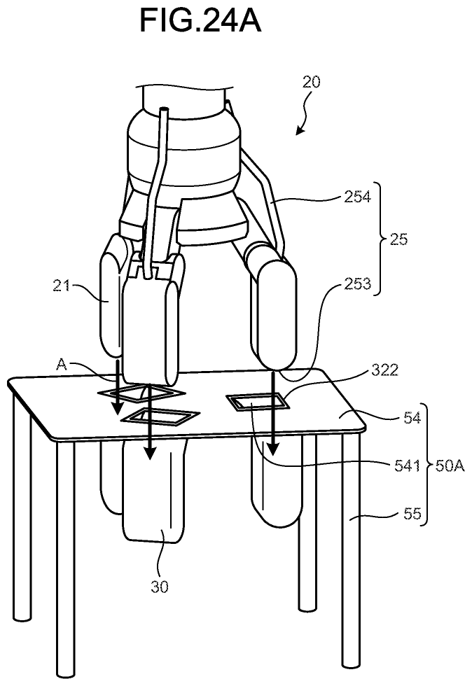

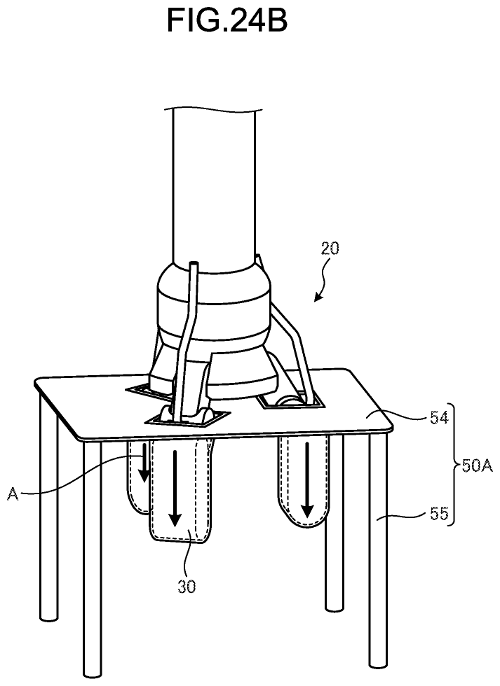

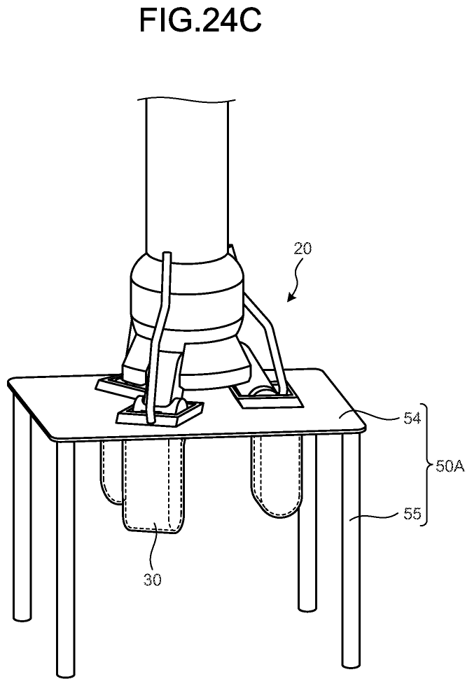

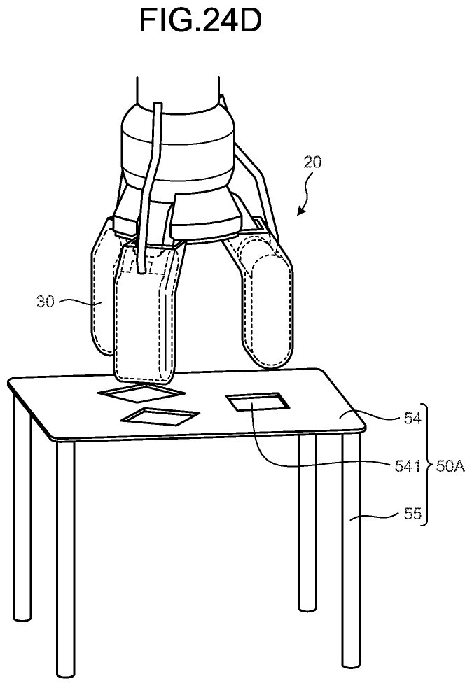

FIG. 24A to FIG. 24D are diagrams schematically illustrating an example of a procedure of attaching the protective cover according to the second modification of the first embodiment. In the second modification, each of protective covers 30 covers a distal end portion beyond the first joint of the finger 21 of the hand 20, and the protective covers 30 of the respective fingers 21 are not joined with the base plate 31 illustrated in FIG. 3. Specifically, the protective covers 30 are attached to the respective fingers 21 independently. The protective covers 30 are formed of a stretchable material.

In addition, in the case of the protective cover 30 as described above, a cover replacement device 50A includes a top board 54 and three or more legs 55 supporting the top board 54, as illustrate in the drawings. The top board 54 is provided with openings 541 to support the protective covers 30 for the fingers 21. In this example, three openings 541 are provided to correspond to the number of fingers 21 of the hand 20. The protective covers 30 are inserted into the three openings 541 respectively, and the protective covers 30 are supported with the top board 54 with stoppers 322 provided on the respective protective covers 30.

The following is an explanation of the method for attaching and detaching the protective covers 30 to and from the hand 20. First, as illustrated in FIG. 24A, the position recognition unit 24 provided on the hand 20 performs positioning such that the positions of the openings 541 of the cover replacement device 50 agree with the positions of the fingers 21 of the hand 20. In this state, the air (gas) A is ejected from the gas holes 253. In this manner, the protective covers 30 are expanded. In this state, as illustrated in FIG. 24B, the hand 20 is moved down toward the protective covers 30, and the fingers 21 are inserted into the protective covers 30. In this operation, because the protective covers 30 are in a state of being expanded with the air A to a degree preventing contact with the fingers 21, the fingers 21 can be easily inserted into the protective covers 30.

Thereafter, as illustrated in FIG. 24C, ejection of the air A from the gas holes 253 is stopped. In this manner, the protective covers 30 are deflated, and brought into close contact with the fingers 21 of the hand 20. Thereafter, as illustrated in FIG. 24D, the hand 20 is moved upward from the cover replacement device 50. In this manner, the protective covers 30 are pulled out of the top board 54, and the protective covers 30 are changed to a state of being attached to the hand 20.

This explanation illustrates the case where the protective covers 30 are brought into close contact with the fingers 21 by deflation caused by stop of supply of the air A into the protective covers 30. As another example, thereafter, the air A may be taken into the gas holes 253 to further enhance adhesion of the protective covers 30 to the fingers 21. This structure enables suppression of falling of the protective covers 30 from the fingers 21 during work.

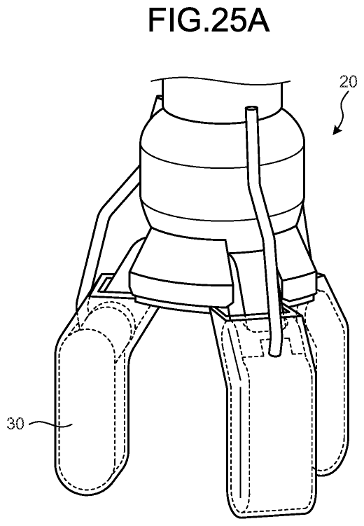

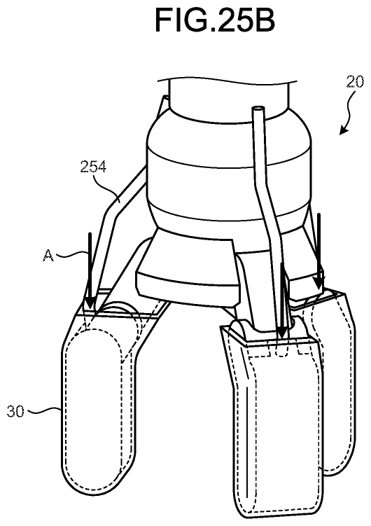

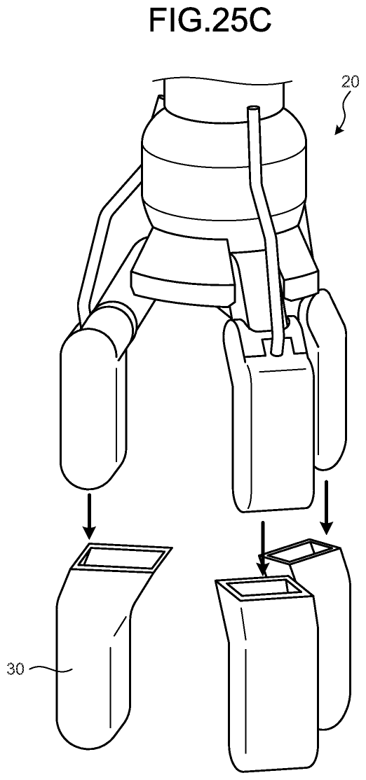

FIG. 25A to FIG. 25C are diagrams schematically illustrating an example of a procedure of a method of removing the protective covers according to the second modification of the first embodiment. First, as illustrated in FIG. 25A, the robot main member 10 is moved to a predetermined position to remove the protective covers 30, and the hand 20 is set to, for example, a state of facing downward. Thereafter, as illustrated in FIG. 25B, the air A is ejected from the gas holes 253, and the protective covers 30 are expanded. Thereafter, as illustrated in FIG. 25C, the state in which the air A is ejected from the gas holes 253 is maintained. In this manner, the protective covers 30 are removed from the fingers 21 of the hand 20, and fall downward. By the method described above, the protective covers 30 are removed from the hand 20.

In the second modification, in the state in which the protective covers 30 are expanded with the air A supplied into the protective covers 30 formed of a stretchable material, the fingers 21 of the hand 20 are inserted into the protective covers 30. Thereafter, supply of the air A is stopped to attach the protective covers 30. In addition, when the protective covers 30 are removed, the air A is supplied into the protective covers 30 to remove the protective covers 30 by air pressure. This structure provides protective covers 30 with higher adhesion to the hand 20.

### Third Modification of First Embodiment

The first embodiment illustrates the case where the protective cover 30 is provided with the identification information 33, such as a QR code (registered trademark). As the identification information 33, symbols, numbers, and/or characters may be used, instead of a QR code (registered trademark). In addition, the protective covers 30 may have different surface colors according to the type of the protective covers 30. However, the surface colors are different from the surface color of the hand 20. This structure enables determination as to whether the protective cover 30 is attached to the hand 20 by imaging the protective cover 30 with the imaging unit 16 of the head part 14 of the robot main member 10 and discriminating the color thereof. In addition, when the protective cover 30 is attached, this structure enables acquisition of the type of the attached protective cover 30.

The different surface colors are used for the protective cover 30 according to the type thereof, and information of the surface color is determined on the basis of image data imaged with the imaging unit 16. This structure enables determination of the type of the protective cover 30 by a simpler image processing technique.

### Fourth Modification of First Embodiment

In the first embodiment, determination as to whether the protective cover 30 is attached to the hand 20 is executed using the identification information 33. The presence/absence of attachment of the protective cover 30 may be checked by another method. For example, a force sensor serving as the attachment check unit may be provided on the arm 13 or the hand 20 of the robot main member 10, and presence/absence of attachment of the protective cover 30 may be determined by checking the weight of the protective cover 30 with the force sensor.

As another example, presence/absence of attachment of the protective cover 30 may be determined by checking the pressure generated by attachment of the protective cover 30 to the hand 20 with the pressure sensing unit 211, such as a force-tactile sensor provided on the hand 20. The pressure sensing unit 211 is a type of the attachment check unit.

As another example, presence/absence of attachment of the protective cover 30 may be determined by observing oscillation or sound generated by hitting or rubbing the tips of the fingers 21 of the hand 20 against each other with an acceleration sensor or a microphone, respectively. The acceleration sensor and the microphone serve as a type of the attachment check unit.

As another example, the hand 20 may be provided with an optical sensor to determine presence/absence of attachment of the protective cover 30 on the basis of change in output of the optical sensor. FIG. 26 is a perspective view schematically illustrating an example of a structure of the hand according to the fourth modification of the first embodiment. In the hand 20, the pressure sensing unit 211 is provided to extend from the portion around the center to the portion around the upper portion of the object holding surface side of each of the fingers 21 in the height direction. Specifically, in FIG. 2, the pressure sensing unit 211 is provided at the top portion of each of the fingers 21. In the fourth modification, the pressure sensing unit 211 is not provided at the top portion of each of the fingers 21. The top portion of each of the fingers 21 is provided with a cover attachment sensing unit 212. The cover attachment sensing unit 212 is an optical sensor, such as a reflection-type photosensor and a time of flight (TOF) sensor. The cover attachment sensing unit 212 is a type of the attachment check unit.

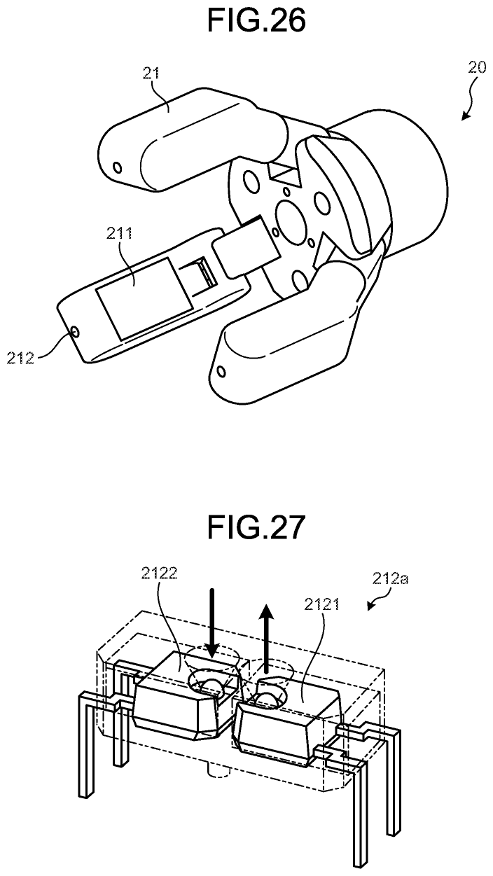

FIG. 27 is a diagram illustrating an example of a structure of a reflection-type photosensor. A reflection-type photosensor 212a serving as a type of the cover attachment sensing unit 212 includes a light-emitting element 2121 and a light-receiving element 2122. The light-emitting element 2121 emits light, for example, upward from the reflection-type photosensor 212a, and the light-receiving element 2122 detects reflected light reflected, for example, above the reflection-type photosensor 212a and returned thereto. Specifically, the reflection-type photosensor 212a senses whether any object exists above the reflection-type photosensor 212a on the basis of presence/absence of detection of the reflected light of the light emitted from the light-emitting element 2121.

FIG. 28 is a diagram illustrating an example in which the protective covers are attached to the hand. For example, as illustrated in FIG. 26, when no protective cover 30 is attached to the hand 20, no objects exist above the reflection-type photosensors 212a. For this reason, reflected light of the light output from the light-emitting element 2121 of the reflection-type photosensor 212a is not made incident on the light-receiving element 2122. Accordingly, it is determined that no protective cover 30 is attached to the hand 20. By contrast, as illustrated in FIG. 28, when the protective covers 30 are attached to the hand 20, the protective covers 30 exist above the reflection-type photosensors 212a. For this reason, the reflected light output from the light-emitting element 2121 of each of the reflection-type photosensors 212a and reflected from the protective cover 30 is made incident on the light-receiving element 2122. In this manner, it is determined that the protective covers 30 are attached to the hand 20. As described above, presence/absence of attachment of the protective cover 30 is determined on the basis of change of the output value at each of the light-receiving elements 2122.

As described above, by directly sensing presence/absence of attachment of the protective cover 30 to the hand 20 or the surface of the robot main member 10, presence/absence of attachment of the protective cover 30 can be sensed at high speed, in comparison with the case of imaging image data of the position to which the attached protective cover 30 is attached each time.

### Fifth Modification of First Embodiment

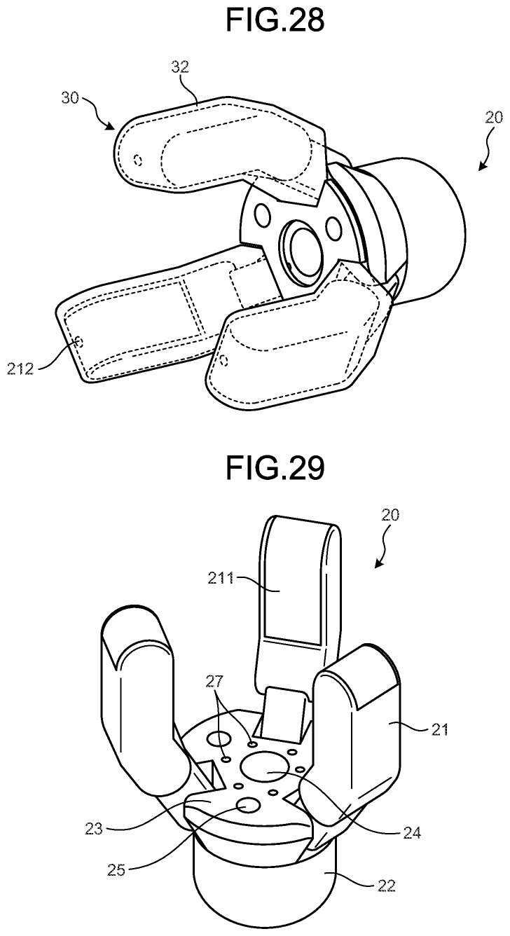

FIG. 29 is a diagram illustrating an example of electric contacts provided in the palm part of the hand, and FIG. 30 is a diagram illustrating an example of electric contacts provided in the base plate of the protective cover. The palm part 23 of the hand 20 is provided with electric contacts 27 serving as a type of the attachment check unit. The electric contacts 27 are connected with the attachment state determination unit 71 of the control device 70. In this example, six electric contacts 27 are provided.

Electric contacts 35 serving as a type of the attachment check unit are also provided on a rear surface of the base plate 31 the protective cover 30. The electric contacts 35 provided on the protective cover 30 are formed of a combination of one or more positions in positions corresponding to the electric contacts 27 of the hand 20. The combination of positions of the electric contacts 35 differs according to the type of the protective cover 30. Specifically, the combination of positions of the electric contacts 35 provided on the protective cover 30 indicates the type of the protective cover 30.

With this structure, when the protective cover 30 is attached to the hand 20, the attachment state determination unit 71 of the robot 1 is enabled to specify the type of the attached protective cover 30 on the basis of electric connection between the electric contacts.

As another example, the protective cover 30 may be provided with an integrated circuit (IC) chip storing identification information therein and an electric contact connected with the IC chip, and the palm part 23 of the hand 20 may be provided with an electric contact. In this case, when the protective cover 30 is attached to the hand 20, the electric contacts are connected, and the attachment state determination unit 71 of the control device 70 is enabled to read out the identification information in the IC chip via the electric contact and specify the type of the protective cover 30.

### Sixth Modification of First Embodiment

In the first embodiment and the modifications thereof, the pressure or the distance is sensed with the pressure sensing unit 211 or the distance sensing unit provided on the hand 20 via the protective cover 30. However, because the protective cover 30 exists between the hand 20 and the held object, sensing capability of the pressure sensing unit 211 or the distance sensing unit deteriorates in comparison with the case where no protective cover 30 exists therebetween. For this reason, a modification in which the protective cover 30 is provided with the pressure sensing unit 211 or the distance sensing unit will be explained hereinafter.

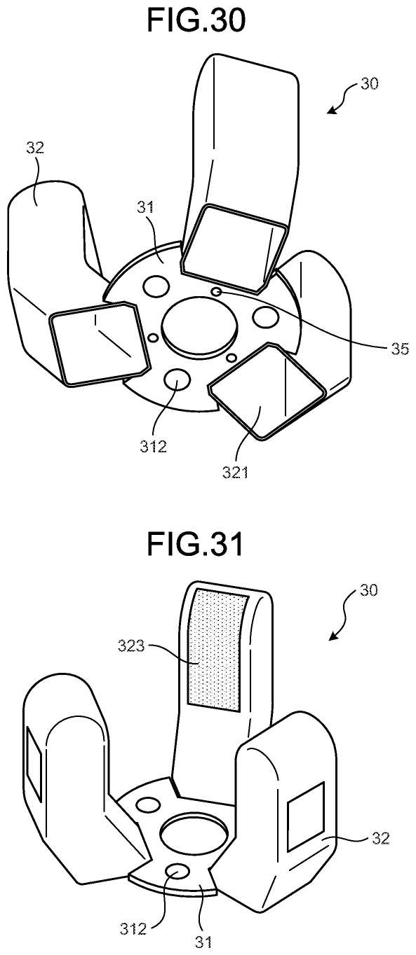

FIG. 31 is a perspective view schematically illustrating an example of the protective cover according to the sixth modification of the first embodiment, and FIG. 32 is a perspective view of a rear side schematically illustrating an example of the protective cover according to the sixth modification of the first embodiment. Sensing units 323 are provided on object holding surfaces of the protective cover 30. In addition, the rear surface of the base plate 31 is provided with electric contacts 324 to transmit information sensed with the sensing units 323 of the respective fingers 21 to the control device 70. A cover part 32 between the sensing unit 323 and the electric contact 324 is provided with a wire (not illustrated).

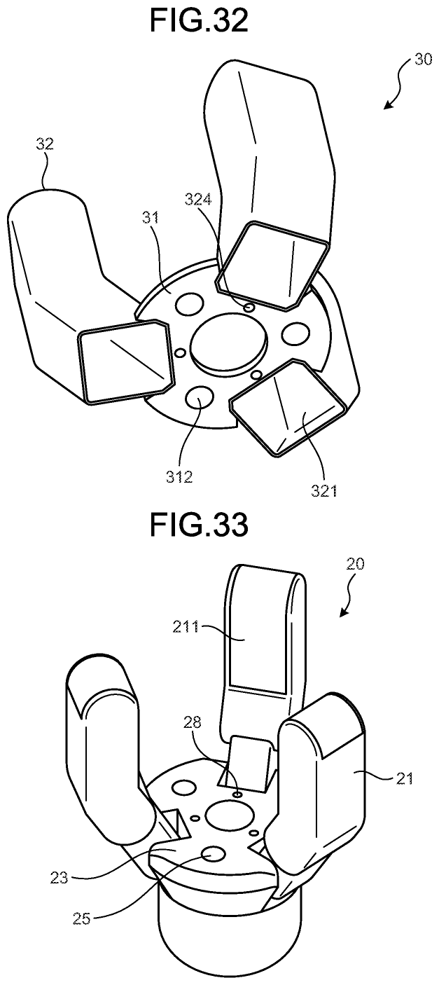

FIG. 33 is a perspective view schematically illustrating an example of the structure of the hand according to the sixth modification of the first embodiment. Electric contacts 28 connected with the control device 70 are provided in positions of the palm part 23 of the hand 20 corresponding to the electric contacts 324 on the rear surface of the base plate 31. The electric contacts 28 are connected with the control device 70 via wires. In this manner, the information sensed with the sensing units 323 of the protective cover 30 is transmitted to the control device 70.

Pressure sensing units, distance sensing units, or temperature sensing units or the like can be used as the sensing units 323. For example, force-tactile sensors of a capacitance change type, an electric change type, or an electromagnetic induction type are used as the pressure sensing units. Proximity sensors of a capacitance change type, an electromagnetic induction type, a magnetic type, or an optical type are used as the distance sensing units. Thermistors or infrared thermometers or the like are used as the temperature sensing units.

In the case where the protective cover 30 requiring electric contact like this is attached to the hand 20, identification information indicating the attachment state of the protective cover 30 and the type of the protective cover 30 may be recognized with electric connection.

In the sixth modification of the first embodiment, the protective cover 30 is provided with the sensing units 323. This structure enables increase in sensitivity in comparison with the case where the pressure sensing units 211 provided on the hand 20 sense the pressure of the held object or the like via the protective cover 30. In addition, in the case where the pressure sensing units 211 provided on the hand 20 sense the pressure or the like via the protective cover 30, calibration is required each time. By contrast, in the case where the protective cover 30 is provided with the sensing units 323, the number of calibrations can be reduced.

### Second Embodiment

Configuration of System according to Second Embodiment In the first embodiment, the control device 70 provided on the robot 1 determines presence/absence of replacement of the attached protective cover 30. However, presence/absence of replacement of the protective cover 30 may be determined with, for example, another information processing device connected to a network. The second embodiment illustrates the case where presence/absence of replacement of the protective cover 30 is determined in a place different from the robot 1, as an example. Only parts different from those of the first embodiment will be explained, and an explanation of the same elements as those of the first embodiment will be omitted.

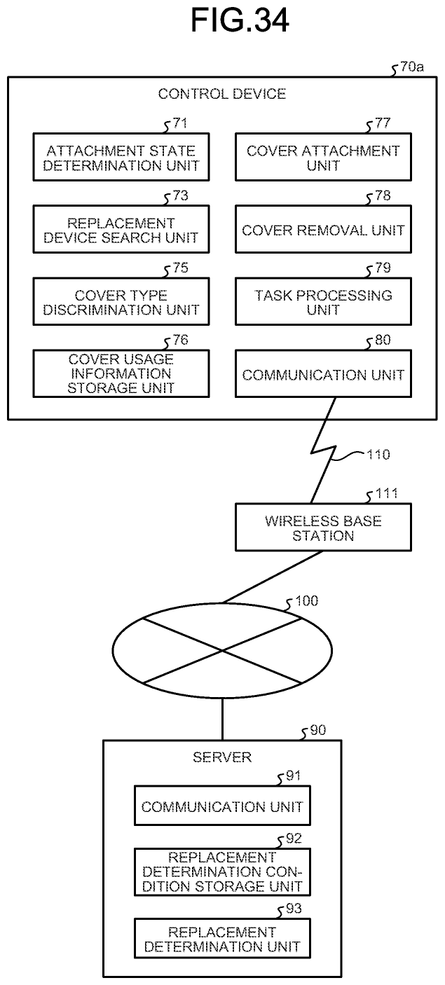

FIG. 34 is a block diagram schematically illustrating an example of a functional configuration of a robot system according to the second embodiment of the present disclosure. In the robot system, a control device 70a provided on the robot 1 is connected with a server 90 determining presence/absence of replacement of the protective cover 30 of the robot main member 10 via a network 100. The network 100 is, for example, a local area network (LAN), a wide area network (WAN), or the Internet. In addition, the control device 70a of the robot 1 and the network 100 are connected via, for example, a wireless network 110. A wireless base station 111 is provided on the network 100 to transfer data between the control device 70a and the server 90. The control device 70 and the wireless base station 111 perform communications by a communication system, such as a wireless LAN such as IEEE802.11ad, IEEE802.11ac, IEEE802.11n, IEEE802.11a, IEEE802.11g, and IEEE802.11b, a wideband-code division multiple access (W-CDMA), and long term evolution (LTE).

The control device 70a includes a communication unit 80, the attachment state determination unit 71, the replacement device search unit 74, the cover type discrimination unit 75, the cover usage information storage unit 76, the cover attachment unit 77, the cover removal unit 78, and the task processing unit 79. The server 90 includes a communication unit 91, the replacement determination condition storage unit 72, and the replacement determination unit 73.

Specifically, the second embodiment has a structure in which the replacement determination condition storage unit 72 and the replacement determination unit 73 of the control device 70 according to the first embodiment are moved to the server 90. Specifically, the server 90 determines whether replacement of the protective cover 30 is required on the basis of the identification information 33 read from the protective cover 30, the cover usage information read from the cover usage information storage unit 76, and the image data of the protective cover 30 and the like transmitted from the control device 70a. The control device 70a transmits the identification information 33, the cover usage information, and the image data of the protective cover 30 to the server 90 via the communication unit 80, and the server 90 transmits information indicating whether replacement of the protective cover 30 is required to the control device 70 via the communication unit 91.

The drawing illustrates the case where one control device 70a is connected to the network 100, but a plurality of control devices 70a may be connected thereto. As another example, the first to the sixth modifications of the first embodiment may be combined with the second embodiment.

The second embodiment has a structure in which the server 90 determines whether replacement of the protective cover 30 is required. This structure enables determination of replacement of the protective cover 30 in an integrated manner. This structure also prevents difference in determination of replacement of the protective cover 30 between robots 1 even in the same use state of the protective cover. In addition, because the server 90 stores therein image data serving as basis for determination as to whether the protective cover 30 is required, accuracy of determination of the defacement degree of the protective cover 30 is enhanced on the basis of the image data by machine learning or the like.

Hardware Configuration

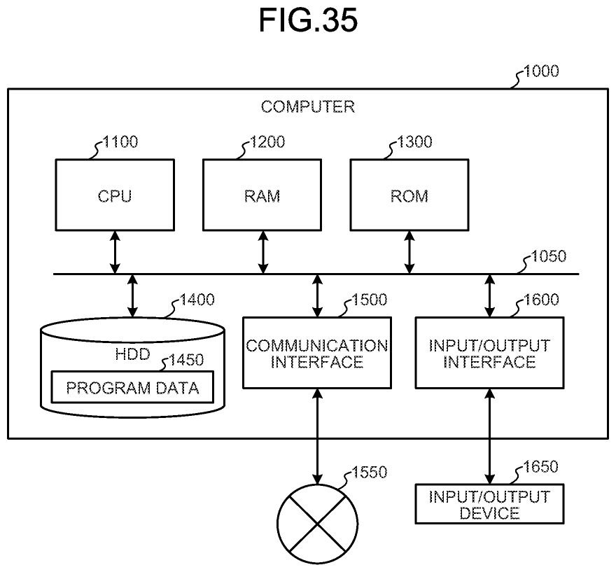

The information processing device, such as the control devices 70 and 70a and the server 90 according to the embodiments described above, is achieved with a computer or the like. The following explanation is made with the control device 70 according to the first embodiment as an example. FIG. 35 is a hardware configuration diagram illustrating an example of a computer achieving functions of the control device. A computer 1000 includes a CPU 1100, a RAM 1200, a read only memory (ROM) 1300, a hard disk drive (HDD) 1400, a communication interface 1500, and an input/output interface 1600. The units of the computer 1000 are connected via a bus 1050.

The CPU 1100 operates on the basis of computer programs stored in the ROM 1300 or the HDD 1400, and controls each of the units. For example, the CPU 1100 develops computer programs stored in the ROM 1300 or the HDD 1400 to the RAM 1200, and executes processing corresponding to the computer programs.

The ROM 1300 stores therein a boot program, such as a basic input output system (BIOS), to be executed with the CPU 1100 when the computer 1000 is started up, and/or a computer program depending on the hardware of the computer 1000, and the like.

The HDD 1400 is a computer-readable recording medium non-temporarily recording a computer program executed with the CPU 1100 and data used with the computer program and the like. Specifically, the HDD 1400 is a recording medium recording the information processing program according to the present disclosure. The information processing program serves as an example of program data 1450.

The communication interface 1500 is an interface to connect the computer 1000 to an external network 1550 (such as the Internet). For example, the CPU 1100 receives a task execution instruction from another device via the communication interface 1500.

The input/output interface 1600 is an interface to connect an input/output device 1650 with the computer 1000. For example, the CPU 1100 receives data from an input device, such as the imaging unit 16 and the position recognition unit 24, via the input/output interface 1600. The CPU 1100 also transmits data to an output device, such as the joining units 25, via the input/output interface 1600. The input/output interface 1600 may also function as a media interface reading a computer program or the like recorded on a certain recording medium (medium). The medium is an optical recording medium, such as a digital versatile disc (DVD) and a phase change rewritable disk (PD), a magneto-optical recording medium, such as a magneto-optical disk (MO), a tape medium, a magnetic recording medium, or a semiconductor memory or the like.

For example, when the computer 1000 functions as the control device 70 according to the first embodiment, the CPU 1100 of the computer 1000 achieves functions of the attachment state determination unit 71, the replacement determination unit 73, the replacement device search unit 74, the cover type discrimination unit 75, the cover attachment unit 77, the cover removal unit 78, and the task processing unit 79 by executing the information processing program loaded onto the RAM 1200. In addition, the HDD 1400 stores therein the information processing program according to the present disclosure and the data in the replacement determination condition storage unit 72 and the cover usage information storage unit 76. The CPU 1100 reads the program data 1450 from the HDD 1400 and executes the program data 1450, but these programs may be acquired from another device via the external network 1550, as another example.

The effects described in the present specification are mere examples and not limited thereto, and other effects may be produced.

The present technique may also have the following structures.
(1)

A robot comprising:

a replacement determination unit determining timing to replace a cover attachable to and detachable from part of a surface of a robot main member in accordance with a determination standard corresponding to usage of the robot; and

a cover replacement unit controlling processing of replacing the cover with the robot main member on the basis of a result of the determination.
(2)

The robot according to (1), wherein the replacement determination unit determines the timing to replace the cover in accordance with the determination standard corresponding to a type of a task executed with the robot as the usage.
(3)

The robot according to (2), wherein the replacement determination unit determines the timing to replace the cover using a type of the cover determined for each type of the task and a lapse degree since attachment of the cover as the determination standard.
(4)

The robot according to any one of (1) to (3), further comprising:

an attachment state determination unit determining presence/absence of attachment of the cover acquired from a result of checking with an attachment check unit checking attachment of the cover to the robot main member, and acquiring the type of the cover, wherein

the robot main member includes the attachment check unit,

the replacement determination unit determines that current time is the timing to replace the cover, when the cover is attached and when cover usage information including the type of the cover and the lapse degree of the cover satisfies the determination standard.
(5)

The robot according to (4), wherein the replacement determination unit instructs the cover replacement unit to attach the cover of a type corresponding to the type of the task, when the cover is not attached.
(6)

The robot according to (4) or (5), wherein

the attachment check unit is an imaging unit imaging the cover, and

the attachment state determination unit identifies the type of the cover using image data imaged with the imaging unit.
(7)

The robot according to any one of (4) to (6), wherein the type of the cover is a surface color of the cover or identification information provided on the cover.
(8)

The robot according to (6), wherein the replacement determination unit further uses a defacement degree of the cover in the image data imaged with the attachment check unit for determination of the timing to replace the cover.
(9)

The robot according to (4), wherein

the robot main member includes n first electric contacts in a cover attachment region,

the cover includes m (mn) second electric contacts,

the attachment check unit senses contact positions of the second electric contacts with the first electric contacts, and

the attachment state determination unit specifies the type of the cover on the basis of the contact positions.
(10)

The robot according to any one of (1) to (9), wherein

the robot main member includes a hand holding an object,

the cover covers a holding surface for the object of the hand, and

the hand and the cover are joined with joining units.
(11)

The robot according to (10), wherein

the joining units are electromagnets provided on the hand and magnets provided on the cover, and

the cover replacement unit attaches and detaches the cover by turning on and off the electromagnets.
(12)

The robot according to (10), wherein

the joining units include a gas hole provided on the hand and a gas intake/outlet connected with the gas hole, and

the cover replacement unit attaches the cover to the hand by taking gas into the gas hole, and removes the cover from the hand by blowing off the gas out of the gas hole.
(13)

The robot according to (10), wherein

the cover is formed of a stretchable material,

the joining units include a gas hole provided on the hand and a gas outlet connected with the gas hole, and

the cover replacement unit attaches the hand to the cover by expanding the cover by blowing off gas from the gas hole, and removes the cover from the hand by blowing off the gas from the gas hole.
(14)

The robot according to (10), wherein

the joining units join the hand to the cover by magnetic force, and

the cover replacement unit removes the cover by applying external force to the cover.
(15)

The robot according to any one of (10) to (14), further comprising:

an attachment state determination unit determining presence/absence of attachment of the cover acquired from a result of checking with an attachment check unit checking attachment of the cover to the robot main member, wherein

the robot main member includes the attachment check unit.
(16)

The robot according to (15), wherein

the attachment check unit is a sensor sensing weight of the cover or pressure caused by attachment of the cover, and

the attachment state determination unit determines presence/absence of attachment of the cover to the hand on the basis of an output result of the sensor.
(17)

The robot according to (15), wherein

the attachment check unit is an optical sensor provided on the hand, and

the attachment state determination unit determines presence/absence of attachment of the cover to the hand on the basis of change in output of the optical sensor.
(18)

The robot according to (15), wherein

the attachment check unit is an acceleration sensor or a microphone, and

the attachment state determination unit determines presence/absence of attachment of the cover to the hand on the basis of oscillation sensed with the acceleration sensor or sound sensed with the microphone when fingertips of the hand are brought into contact with each other.
(19)

The robot according to any one of (10) to (18), wherein the cover includes a sensor on the holding surface.
(20)

The robot according to (19), wherein the sensor is a pressure sensing unit, a distance sensing unit, or a temperature sensing unit.
(21)

The robot according to (1), wherein the replacement determination unit is connected with the cover replacement unit via a network.
(22)

A method for controlling a robot, the method comprising:

determining timing to replace a cover attachable to and detachable from part of a surface of a robot main member in accordance with a determination standard corresponding to usage of the robot; and

controlling processing of replacing the cover with the robot main member on the basis of a result of the determination.
(23)

A computer program causing a computer to execute:

a step of determining timing to replace a cover attachable to and detachable from part of a surface of a robot main member in accordance with a determination standard corresponding to usage of the robot; and

a step of controlling processing of replacing the cover with the robot main member on the basis of a result of the determination.

### REFERENCE SIGNS LIST

1 ROBOT

10 ROBOT MAIN MEMBER

11 BASE PART

12 BODY PART

13 ARM

14 HEAD PART

15 MOVING MECHANISM

16 IMAGING UNIT

20 HAND

21 FINGER

22 SUPPORT PART

23 PALM PART

24 POSITION RECOGNITION UNIT

25, 53, 312 JOINING UNIT

27, 28, 35, 324 ELECTRIC CONTACT

30 PROTECTIVE COVER

31 BASE PLATE

32 COVER PART

33 IDENTIFICATION INFORMATION

50, 50A COVER REPLACEMENT DEVICE

51 BASE

53 SUPPORT PORTION

70 JOINING UNIT

70, 70a CONTROL DEVICE

71 ATTACHMENT STATE DETERMINATION UNIT

72 REPLACEMENT DETERMINATION CONDITION STORAGE UNIT

73 REPLACEMENT DETERMINATION UNIT

74 REPLACEMENT DEVICE SEARCH UNIT

75 COVER TYPE DISCRIMINATION UNIT

76 COVER USAGE INFORMATION STORAGE UNIT

77 COVER ATTACHMENT UNIT

78 COVER REMOVAL UNIT

79 TASK PROCESSING UNIT

80, 91 COMMUNICATION UNIT

90 SERVER

100 NETWORK

110 WIRELESS NETWORK

111 WIRELESS BASE STATION

211 PRESSURE SENSING UNIT

212 COVER ATTACHMENT SENSING UNIT

251, 253 GAS HOLE

252, 254 GAS PIPE

311 OPENING PART

321 INSERTION SLOT

322 STOPPER

323 SENSING UNIT

A AIR

1. A robot comprising:
a replacement determination unit determining timing to replace a cover attachable to and detachable from part of a surface of a robot main member in accordance with a determination standard corresponding to usage of the robot; and
a cover replacement unit controlling processing of replacing the cover with the robot main member on the basis of a result of the determination.

2. The robot according to claim 1, wherein the replacement determination unit determines the timing to replace the cover in accordance with the determination standard corresponding to a type of a task executed with the robot as the usage.

3. The robot according to claim 2, wherein the replacement determination unit determines the timing to replace the cover using a type of the cover determined for each type of the task and a lapse degree since attachment of the cover as the determination standard.

4. The robot according to claim 3, further comprising:
an attachment state determination unit determining presence/absence of attachment of the cover acquired from a result of checking with an attachment check unit checking attachment of the cover to the robot main member, and acquiring the type of the cover, wherein
the robot main member includes the attachment check unit,
the replacement determination unit determines that current time is the timing to replace the cover, when the cover is attached and when cover usage information including the type of the cover and the lapse degree of the cover satisfies the determination standard.

5. The robot according to claim 4, wherein the replacement determination unit instructs the cover replacement unit to attach the cover of a type corresponding to the type of the task, when the cover is not attached.

6. The robot according to claim 4, wherein
the attachment check unit is an imaging unit imaging the cover, and
the attachment state determination unit identifies the type of the cover using image data imaged with the imaging unit.

7. The robot according to claim 6, wherein the type of the cover is a surface color of the cover or identification information provided on the cover.

8. The robot according to claim 6, wherein the replacement determination unit further uses a defacement degree of the cover in the image data imaged with the attachment check unit for determination of the timing to replace the cover.

9. The robot according to claim 4, wherein
the robot main member includes n first electric contacts in a cover attachment region,
the cover includes m (mn) second electric contacts,
the attachment check unit senses contact positions of the second electric contacts with the first electric contacts, and
the attachment state determination unit specifies the type of the cover on the basis of the contact positions.

10. The robot according to claim 1, wherein
the robot main member includes a hand holding an object,
the cover covers a holding surface for the object of the hand, and
the hand and the cover are joined with joining units.

11. The robot according to claim 10, wherein
the joining units are electromagnets provided on the hand and magnets provided on the cover, and
the cover replacement unit attaches and detaches the cover by turning on and off the electromagnets.

12. The robot according to claim 10, wherein
the joining units include a gas hole provided on the hand and a gas intake/outlet connected with the gas hole, and
the cover replacement unit attaches the cover to the hand by taking gas into the gas hole, and removes the cover from the hand by blowing off the gas out of the gas hole.

13. The robot according to claim 10, wherein
the cover is formed of a stretchable material,
the joining units include a gas hole provided on the hand and a gas outlet connected with the gas hole, and
the cover replacement unit attaches the hand to the cover by expanding the cover by blowing off gas from the gas hole, and removes the cover from the hand by blowing off the gas from the gas hole.

14. The robot according to claim 10, wherein
the joining units join the hand to the cover by magnetic force, and
the cover replacement unit removes the cover by applying external force to the cover.

15. The robot according to claim 10, further comprising:
an attachment state determination unit determining presence/absence of attachment of the cover acquired from a result of checking with an attachment check unit checking attachment of the cover to the robot main member, wherein
the robot main member includes the attachment check unit.

16. The robot according to claim 10, wherein the cover includes a sensor on the holding surface.

17. The robot according to claim 16, wherein the sensor is a pressure sensing unit, a distance sensing unit, or a temperature sensing unit.

18. The robot according to claim 1, wherein the replacement determination unit is connected with the cover replacement unit via a network.

19. A method for controlling a robot, the method comprising:
determining timing to replace a cover attachable to and detachable from part of a surface of a robot main member in accordance with a determination standard corresponding to usage of the robot; and
controlling processing of replacing the cover with the robot main member on the basis of a result of the determination.

20. A computer program causing a computer to execute:
a step of determining timing to replace a cover attachable to and detachable from part of a surface of a robot main member in accordance with a determination standard corresponding to usage of the robot; and
a step of controlling processing of replacing the cover with the robot main member on the basis of a result of the determination.
